(19) United States
(12) Patent Application Publication
(10) Pub. No.: US 2020/0284014 A1
(43) Pub. Date: Sep. 10, 2020

(54) TOILET REMOTE CONTROLLER

(71) Applicant: LIXIL Corporation, Tokyo (JP)

(72) Inventors: Ryuhei YAMASAKI, Tokyo (JP); Hideyuki AKASAKI, Tokyo (JP); Nobuyasu MIZUNO, Tokyo (JP); Keiko NAKAGAWA, Tokyo (JP); Tomokazu TOYA, Tokyo (JP)

(73) Assignee: LIXIL Corporation, Tokyo (JP)

(21) Appl. No.: 16/812,039

(22) Filed: Mar. 6, 2020

(30) Foreign Application Priority Data
Mar. 8, 2019 (JP) 2019-042286
Mar. 8, 2019 (JP) 2019-042287
Mar. 8, 2019 (JP) 2019-042288

(51) Int. Cl. E03D 5/10; E03D 9/08

(52) U.S. Cl. CPC E03D 5/10; H01R 13/6205; E03D 9/08

(57) ABSTRACT

Provided is a toilet remote controller for remotely operating a toilet device. The toilet remote controller includes a remote controller main body. The remote controller main body includes a first operation unit, a case, and a cover panel. The case forms a storage space for storing an electrical component. The cover panel is provided at a position corresponding to the first operation unit and covers the case with light permeability.

### CROSS-REFERENCE TO RELATED APPLICATIONS

This application claims the priority of Japanese Application No. 2019-042286, filed Mar. 8, 2019, Japanese Application No. 2019-042287, filed Mar. 8, 2019, and Japanese Application No. 2019-042288, filed Mar. 8, 2019, the entire contents of each of which are incorporated herein by reference.

### FIELD OF THE DISCLOSURE

The present disclosure relates to a toilet remote controller.

### BACKGROUND OF THE DISCLOSURE

JP 2011-84867A discloses a conventional toilet remote controller device. The toilet remote controller device includes a remote controller main body, and various operation switches are arranged on the outer surface of the remote controller main body.

### SUMMARY OF THE DISCLOSURE

The toilet remote controller device of JP 2011-84867A has an improved design that includes a symmetrical shape, a symmetrical arrangement, or the like for the remote controller main body or the operation switch. Such a remote controller for toilets is required to further improve the designability.

The present disclosure includes a toilet remote controller that can make designability favorable.

In some embodiments, provided is a toilet remote controller for remotely operating a toilet device, including a remote controller main body including: an operation unit for operating the toilet device; a case forming a storage space for storing an electrical component; and a cover panel that is provided at a position corresponding to the operation unit and covers the case with light permeability.

### BRIEF DESCRIPTION OF THE FIGURES

FIG. 1 is a perspective view showing the front of a toilet remote controller, according to some embodiments;

FIG. 2 is a perspective view showing the back of the toilet remote controller, according to some embodiments;

FIG. 3 is an exploded perspective view showing the toilet remote controller, according to some embodiments;

FIG. 4 is a view showing the toilet remote controller, specifically, a transverse cross-sectional view in which the internal structure is omitted, according to some embodiments;

FIG. 5 is a view showing the toilet remote controller, specifically, a longitudinal cross-sectional view in which the internal structure is omitted, according to some embodiments;

FIG. 6 is a cross-sectional view schematically showing a cover panel, according to some embodiments;

FIG. 7 is a front view showing the toilet remote controller, according to some embodiments;

FIG. 8 is a toilet remote controller, specifically, a perspective view showing the back surface side of the remote controller main body and the front surface side of a holder, according to some embodiments;

FIG. 9 is a front view showing a state where the remote controller main body is held on the holder fixed to a mounting surface, according to some embodiments;

FIG. 10A is a cross-sectional view showing a state where the remote controller main body is held on the holder fixed to the mounting surface, specifically, a cross-sectional view corresponding to a cross section at the position X-X in FIG. 9;

FIG. 10B is an enlarged view of the main part of FIG. 10A;

FIG. 11 is a rear view showing the back surface of the remote controller main body, according to some embodiments;

FIG. 12 is a perspective view showing the holder in a state where a lid member is removed, according to some embodiments;

FIG. 13 is a toilet remote controller, specifically, a perspective view showing a state before the remote controller main body is mounted to a holder, according to some embodiments;

FIG. 14 is a rear view showing the back surface of the remote controller main body, according to some embodiments;

FIG. 15 is a front view showing a state where the remote controller main body is held on the holder fixed to the mounting surface, according to some embodiments;

FIG. 16 is a cross-sectional view showing the state where the remote controller main body is held on the holder fixed to the mounting surface, according to some embodiments;

FIG. 17 is a perspective view showing a state before assembly of a first member and a second member, according to some embodiments;

FIG. 18 is a front view showing the holder in a state where a pair of holding portions approach each other, according to some embodiments;

FIG. 19 is a rear view showing the holder in the state where the pair of holding portions approach each other, according to some embodiments; and

FIG. 20 is a rear view showing the holder in a state where the pair of holding portions is separated from each other, according to some embodiments.

### DETAILED DESCRIPTION OF THE DISCLOSURE

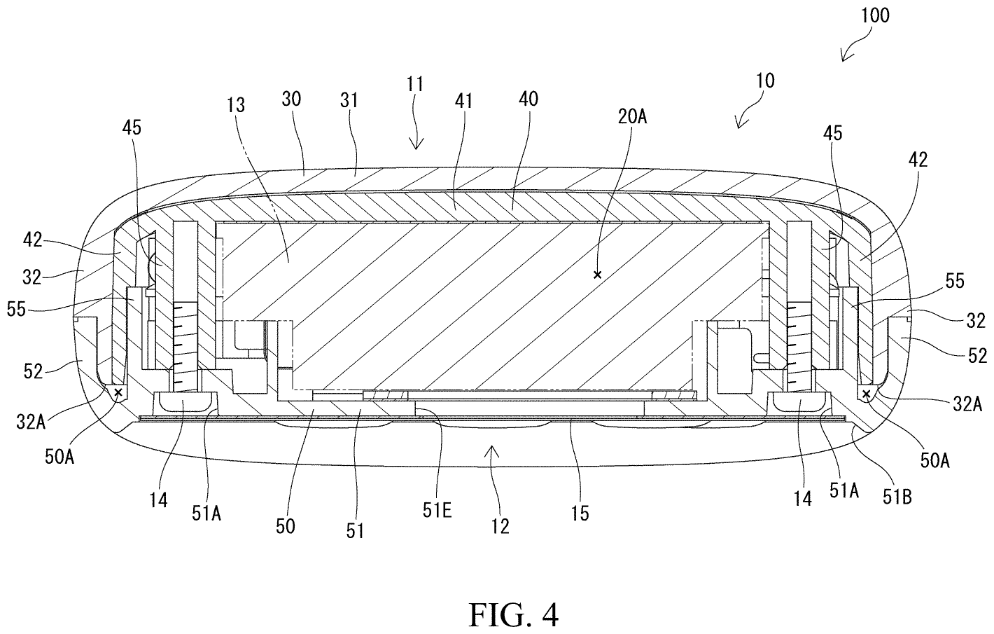

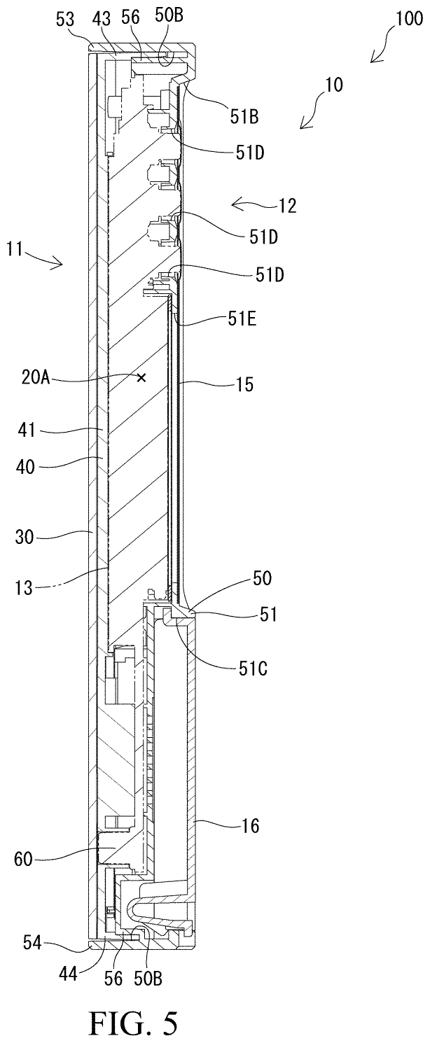

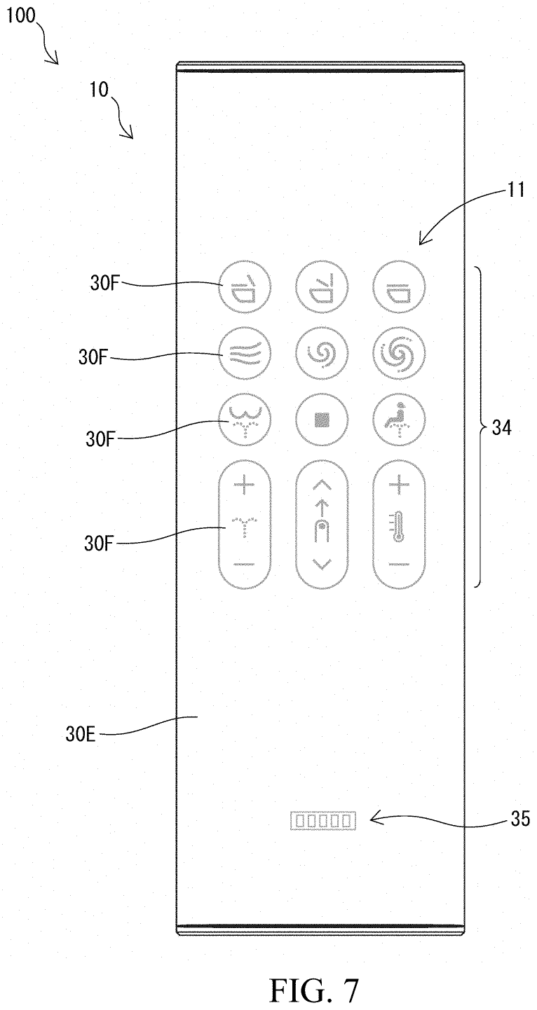

In the following description, an up-and-down direction is based on the up-and-down direction in FIGS. 5 and 7, and a front-back direction and a left-and-right direction are based on the up-and-down direction and the left-and-right directions in FIG. 4, respectively. That is, a description will be given assuming that in a state where a lower wall portion 54 described later is placed on a horizontal plane, a front direction of a surface on which a first operation unit 11 described later is arranged is a front side, the upper side is an upside, and a direction orthogonal to the front-back direction and the up-and-down direction is the left-and-right direction.

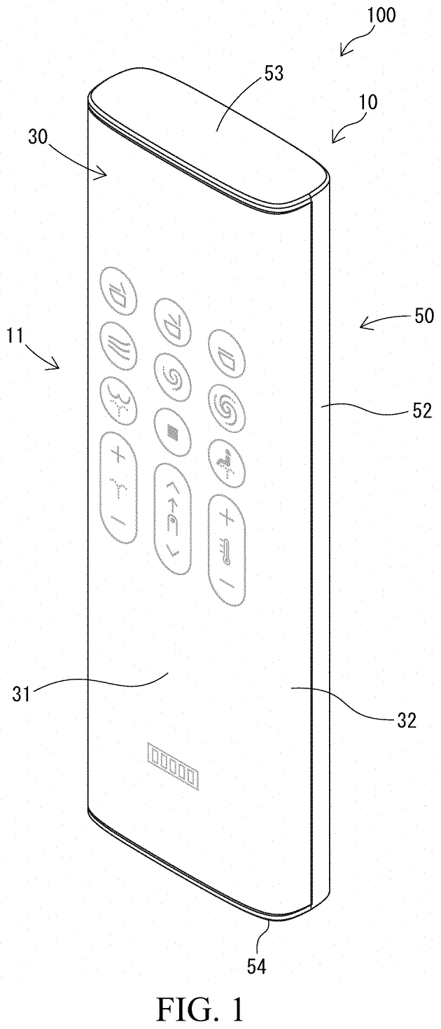

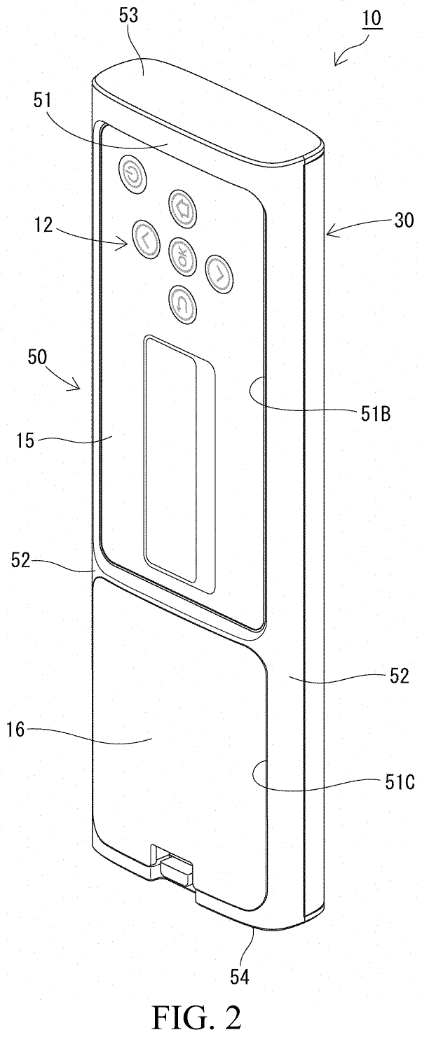

A toilet remote controller 100 according to some embodiments is a device for remotely operating a toilet device (not shown). The toilet remote controller 100 includes a remote controller main body 10. As shown in FIGS. 1 and 2, the remote controller main body 10 has a columnar outer shape that is longer in the up-and-down direction than the left-and-right direction and is slightly flat in the front-back direction. The remote controller main body 10 includes a first operation unit 11 arranged on the front side and a second operation unit 12 arranged on the back side. The first operation unit 11 is an operation unit for performing operations such as an opening/closing function of a toilet lid and a toilet seat of the toilet device, a hot water shower function, and a toilet flushing function. The first operation unit 11 employs electrostatic capacitance touch switches. The second operation unit 12 is an operation unit for performing setting operations for various functions of the toilet device described above. The second operation unit 12 employs contact type switches. The remote controller main body 10 is detachably mounted to a wall surface of a toilet room via a holder (not shown). The remote controller main body 10 is mounted to the holder on the wall in a form in which the back surface is opposed to the wall surface.

As shown in FIGS. 1 to 3, the remote controller main body 10 includes a case 20 and a cover panel 30. The case 20 forms a storage space 20A for storing an electrical component 13 that includes the above-described switches, a light source 60 described later, and the like. The case 20 includes a first case member 40 on the front side and a second case member 50 on the back side. The first case member 40 and the second case member 50 are each made of a hard synthetic resin such as acrylonitrile butadiene styrene (ABS). The first case member 40 and the second case member 50 are combined with each other to form the storage space 20A. The first case member 40 and the second case member 50 are combined by a plurality of tapping screws 14 fastened from the second case member 50 side on the back side.

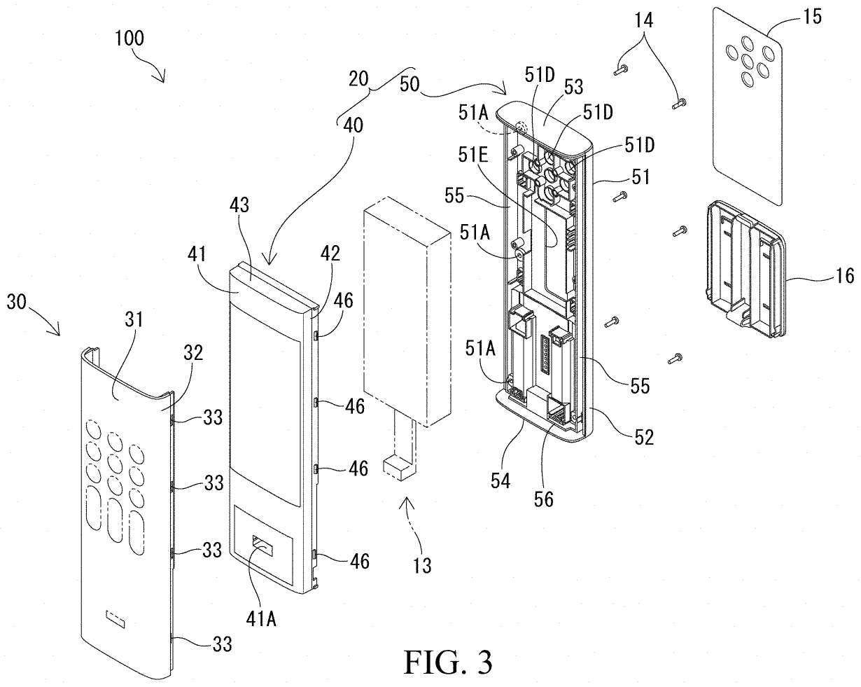

As shown in FIGS. 3 to 5, the first case member 40 includes a front wall portion 41, side wall portions 42, an upper end wall portion 43, and a lower end wall portion 44. The front wall portion 41 is formed to be gently curved backward as approaching from the center to the left and right sides. On the inner surface of the front wall portion 41, bosses 45 to which the tapping screws 14 are fastened are provided at a plurality of locations. A lower portion of the front wall portion 41 is formed with a through hole 41A formed so as to penetrate the front and back surfaces. The through hole 41A is a rectangular hole whose longitudinal direction is the left-and-right direction. The through hole 41A is a window hole for allowing light from the light source 60 described later as the electrical component 13 to appear outside the case 20 when the light source 60 is turned on in the storage space 20A.

As shown in FIGS. 3 and 4, the pair of left and right side wall portions 42 is provided in a form extending backward from left and right ends of the front wall portion 41. The side wall portions 42 are each formed in a stepped shape in which the base end side (connection portion side with the front wall portion 41) projects inward (back surface side) than the distal end side. Locking portions 46 are provided on the outer surface of each side wall portion 42. As shown in FIG. 3, the plurality of locking portions 46 is provided in line in the up-and-down direction. The locking portions 46 are locked to locked portions 33 of the cover panel 30 described later, respectively. In some embodiments, the locking portions 46 and the locked portions 33 adopt a so-called snap-fit structure as a locking form. The locking portions 46 are claw portions that are protrudingly formed.

As shown in FIGS. 3 and 5, the upper and lower end wall portions 43 and 44 are provided in a form extending backward from the upper and lower ends of the front wall portion 41, respectively. Like the side wall portions 42, the end wall portions 43 and 44 are each formed in a stepped shape in which the base end side (connection portion side with the front wall portion 41) projects inward (back surface side) than the distal end side. The left and right end portions of the upper end wall portion 43 and the lower end wall portion 44 are connected to the upper and lower end portions of the side wall portions 42, respectively. It can be said that the upper and lower end wall portions 43 and 44 having such configuration form a peripheral wall in a form surrounding the outer peripheral edge of the front wall portion 41 together with the side wall portions 42.

As shown in FIGS. 3 to 5, the second case member 50 includes a back wall portion 51, outer wall portions 52 (exemplified as a cover portion), an upper wall portion 53, a lower wall portion 54, inner wall portions 55, and inner end wall portions 56. The back wall portion 51 is formed in a form that gently curves forward as approaching from the center to the left and right sides. As shown in FIGS. 4 and 5, the back wall portion 51 is formed with counterbores 51A, a recessed portion 51B, and a storage portion 51C. The tapping screws 14 used for the combination of the second case member 50 and the first case member 40 are inserted into the counterbores 51A. The counterbores 51A are formed at a plurality of locations on the bottom surface of the recessed portion 51B and the bottom surface of the storage portion 51C.

As shown in FIGS. 2 and 5, the recessed portion 51B is formed by recessing the outer surface of the back wall portion 51 to the front side (inner surface side). The recessed portion 51B is formed in a large range from the upper end side portion to the over half of the back wall portion 51. The second operation unit 12 is provided in the recessed portion 51B. The bottom surface of the recessed portion 51B is formed flat, and a plurality of holes 51D for switches of the second operation unit 12 and a hole 51E for a small liquid crystal display (LCD) on which a setting screen is displayed when the second operation unit 12 is operated are formed so as to penetrate the front and back surfaces. A name plate 15 is affixed to the bottom surface of the recessed portion 51B by a double-sided tape (not shown). The name plate 15 is formed by printing on a transparent resin sheet such as polyethylene terephthalate (PET). The recessed portion 51B is also an engagement portion with a holder when the remote controller main body 10 is fixed to the wall surface. The remote controller main body 10 is held in an engaged state by a magnetic force of a magnet (not shown) arranged in at least one of the remote controller main body 10 and the holder by fitting the holder into the recessed portion 51B.

As shown in FIGS. 2 and 5, the storage portion 51C is formed below the recessed portion 51B so as to be adjacent thereto. The storage portion 51C is a portion in which a dry battery serving as a power source for the electrical component 13 is stored. The storage portion 51C is closed by fitting a lid member 16, and the inner space is concealed. The outer surface of the lid member 16 is formed in a curved surface shape that is continuous with the curved surface shape of the outer surface of the back wall portion 51 in a state where the lid member 16 is fitted to the storage portion 51C.

As shown in FIG. 4, the outer wall portions 52 are provided at left and right end portions of the back wall portion 51. The outer wall portions 52 each have a curved surface shape having a form continuous with the curved surface shape of the back wall portion 51, and are formed to protrude from the left and right end portions of the back wall portion 51 while being curved forward (see FIG. 2). The outer wall portions 52 cover the end portions of the cover panel 30. Specifically, the outer wall portions 52 cover end portions 32A of panel side portions 32 described later of the cover panel 30.

As shown in FIG. 5, the upper wall portion 53 and the lower wall portion 54 are respectively provided in a form extending forward from the upper and lower ends of the back wall portion 51. The upper wall portion 53 and the lower wall portion 54 each have a flat plate shape. The outer shape of the upper wall portion 53 and the lower wall portion 54 in a plan view is a substantially symmetrical shape in the front-back direction. Specifically, the upper wall portion 53 and the lower wall portion 54 have shapes in which the outer shapes on the back end side in a plan view are curved along the outer surface shapes of the back wall portion 51 and the outer wall portions 52. The outer shapes on the front end side of the upper wall portion 53 and the lower wall portion 54 are each a curved shape along the outer surface shape of the cover panel 30 described later.

As shown in FIG. 4, the inner wall portions 55 are provided at left and right end portions of the back wall portion 51, respectively. The inner wall portions 55 each have a flat plate shape. The inner wall portions 55 are formed to extend forward from the inner surface of the back wall portion 51. In other words, the inner wall portions 55 are formed so as to protrude in a flat plate shape from the back surface (inner surface) of the back wall portion 51 in such a form that gaps 50A at predetermined intervals are respectively formed between the inner wall portions 55 and the inner surfaces of the outer wall portions 52 formed to be curved forward from the end portions of the back wall portion 51. As shown in FIG. 4, the front end surfaces of the inner wall portions 55 abut against the steps of the side wall portions 42 of the first case member 40 when the second case member 50 is combined with the first case member 40, and at the same time, the outer side surfaces of the inner wall portions 55 are overlaid on the inner side surfaces of the side wall portions 42.

As shown in FIG. 5, the inner end wall portions 56 are erected on the inner surface of the back wall portion 51 that is on the inner side of the upper wall portion 53 and the lower wall portion 54. The inner end wall portions 56 are provided at a predetermined interval from the upper wall portion 53 and the lower wall portion 54 toward the center direction. The inner end wall portions 56 are formed to extend forward from the inner surface of the back wall portion 51. In other words, the inner end wall portions 56 are formed so as to protrude in a flat plate shape from the back surface (inner surface) of the back wall portion 51 in such a form that gaps 50B at predetermined intervals are respectively formed between the inner end wall portions 56 and the inner surfaces of the upper wall portion 53 and the lower wall portion 54. As shown in FIG. 5, the front end surfaces of the inner end wall portions 56 abut against the steps of the upper and lower end wall portions 43 and 44 of the first case member 40 when the second case member 50 is combined with the first case member 40, and at the same time, the outer side surfaces of the inner end wall portions 56 are overlaid on the inner side surfaces of the end wall portions 43 and 44.

The cover panel 30 is provided at a position corresponding to the first operation unit 11 and covers the case 20 with light permeability. In some embodiments, the cover panel 30 covers the outer surface of the first case member 40 as shown in FIGS. 4 and 5. Thereby, in the remote controller main body 10, the outer surface of the cover panel 30 and the outer surface of the second case member 50 are exposed, and the outer surface of the first case member 40 is covered with the cover panel 30. As shown in FIG. 4, the shape of the inner surface of the cover panel 30 has a shape curved in a recessed shape following the outer surface shape of the first case member 40. Thus, when the cover panel 30 is assembled to the first case member 40, the first case member 40 is fitted so that the inner surface of the cover panel 30 and the outer surface of the first case member 40 (outer surfaces of the front wall portion 41 and the side wall portions 42) are overlaid on each other. The outer surface of the cover panel 30 is formed in a smooth surface shape with no irregularities as a whole from the front to the side. The “smooth surface shape” means that there are no steps, protrusions, etc., and it is not intended that there are no fine irregularities (for example, those formed due to surface treatment such as embossing, blasting, etc.).

As shown in FIG. 4, the cover panel 30 includes a panel front portion 31 and the panel side portions 32. The panel front portion 31 is formed in a form that gently curves backward from the center toward the left and right end portions. The panel side portions 32 are provided so as to be connected to left and right end portions of the panel front portion 31. The panel side portions 32 each have a curved surface shape in a form that is continuous with the curved surface shape of the panel front portion 31, and are formed to protrude from the left and right end portions of the panel front portion 31 while being further curved backward.

As shown in FIG. 3, locked portions 33 are provided on the outer surface of the panel side portions 32. The locked portions 33 are provided in line in the up-and-down direction. The locked portions 33 are respectively locked with the above-described locking portions 46 provided on the first case member 40. The cover panel 30 and the first case member 40 are held in a combined state by the locking of the locking portions 46 and the locked portions 33. In some embodiments, the locked portions 33 are hole portions, and are locked with the locking portions 46 that are claw portions by a snap fit structure. The combined state of the cover panel 30 and the first case member 40 is maintained not only by the locking of the locking portions 46 and the locked portions 33, but also by adhesion by a double-sided tape (not shown) interposed between the inner surface of the panel front portion 31 and the outer surface of the front wall portion 41.

As shown in FIG. 4, the end portions 32A of the panel side portions 32 are covered with the outer wall portions 52. Specifically, the panel side portions 32 are each formed in a stepped shape in which the base end side (panel front portion 31 side) projects outward than the distal end side. In the assembled state, the front end surfaces of the outer wall portions 52 abut against the steps of the panel side portions 32, and the outer surfaces on the distal end side of the panel side portions 32 are overlaid on the inner surfaces of the outer wall portions 52. The outer surface of the cover panel 30 and the outer surface of the second case member 50 combined in this way form a continuous surface without a step in the front-back direction.

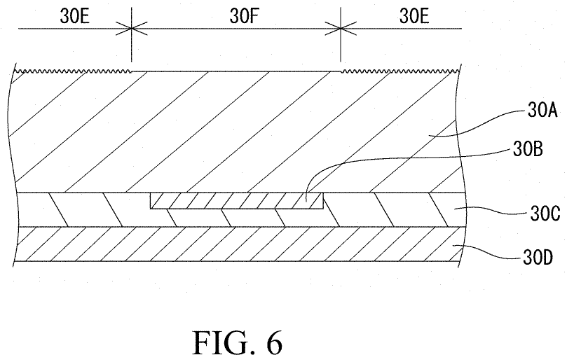

In some embodiments, the cover panel 30 is formed having a plurality of layers. Specifically, as shown in FIG. 6, the cover panel 30 includes a base layer 30A, a printing layer 30B, a first coating layer 30C, and a second coating layer 30D. The base layer 30A is made of a transparent resin such as polycarbonate (PC). The printing layer 30B is formed on the back surface (inner surface) of the base layer 30A. The printing layer 30B is a layer printed with a display of characters, figures, symbols, patterns, etc., and can be formed on at least a part of the back surface of the base layer 30A. Specifically, in cases, as the printing layer 30B, a layer printed with a plurality of pictograms related to the operation of the toilet device is formed at a portion corresponding to the first operation unit 11 (see FIG. 7), and a layer printed with a logo is formed at a portion that is below the plurality of pictograms and corresponds to the through hole 41A of the first case member 40 (see FIG. 7). These printing layers 30B are formed as being divided into a plurality of portions. The printing layer 30B on which the pictograms are printed constitutes a first display unit 34 (see FIG. 7) described later. The printing layer 30B on which the logo is printed constitutes a second display unit 35 (see FIG. 7) described later.

The first coating layer 30C is a layer that entirely forms a coating film on the back surface of the base layer 30A over the printing layer 30B. The first coating layer 30C forms a layer by a coating with a color similar to the color of the case 20. The second coating layer 30D is a layer that further forms a coating film over the first coating layer 30C. The second coating layer 30D is a color coating having a silver metallic luster. The second coating layer 30D reflects incident light from the outer surface side, thereby suppressing see-through of the portion inside the cover panel 30.

As shown in FIGS. 6 and 7, the cover panel 30 includes an opaque region 30E and a transparent region 30F on the outer surface. The opaque region 30E is a region where surface treatment such as embossing is applied to the surface of the base layer 30A. The transparent region 30F is a region that is not subjected to surface treatment. The transparent region 30F is formed on the outer surfaces of the portions of the printing layers 30B corresponding to the first operation unit 11. The opaque region 30E is formed on the entire outer surface of a portion excluding the transparent region 30F. The opaque region 30E has light permeability but not transparent due to the surface treatment.

As shown in FIG. 7, the cover panel 30 includes a first display unit 34 and a second display unit 35. The first display unit 34 and the second display unit 35 are each a portion where the printing layer 30B is formed on the inner surface of the cover panel 30. Specifically, the first display unit 34 is a portion where pictograms related to the operation of the toilet device are displayed. The second display unit 35 is a portion where the logo is displayed. The first display unit 34 is provided in the transparent region 30F. Therefore, in the first display unit 34, the pictograms by the printing layers 30B printed on the inner surface can be clearly visually recognized. The second display unit 35 is provided in the opaque region 30E. Therefore, in the second display unit 35, the logo by the printing layer 30B printed on the inner surface can be visually recognized with a hazy outline. As described above, the displays formed by the printing layers 30B are provided in the regions having the different surface treatments, that is, the transparent region 30F and the opaque region 30E, so that the first display unit 34 and the second display unit 35 are displayed with different moods.

In some embodiment, the remote controller main body 10 includes the light source 60. The light source 60 constitutes a part of the electrical component 13. As shown in FIG. 5, the light source 60 is arranged in the storage space 20A behind the second display unit 35. The light source 60 is, for example, a three-color LED. The light source 60 can emit light in different colors and is controlled in different light emission states such as lighting and blinking. Thus, the availability of the operation of at least one of the first operation unit 11 and the second operation unit 12, the power state, and the like can be notified by the difference in the emission color and the emission state. The light source 60 is provided so as to be able to irradiate the second display unit 35 from behind through the through hole 41A of the first case member 40, and when it is lit, the logo that is the display of the second display unit 35 can be displayed so as to be floated.

Next, functions and effects of the remote controller main body 10 will be described. When the remote controller main body 10 is assembled, first, the cover panel 30 and the first case member 40 are assembled. Specifically, a double-sided tape (not shown) is affixed to the outer surface of the front wall portion 41 of the first case member 40, and the cover panel 30 is overlaid on the first case member 40 in this state. Then, the locked portions 33 on the cover panel 30 side and the locking portions 46 on the first case member 40 side are locked. Since the locking portions 46 and the locked portions 33 are locked by a snap-fit structure, assembling is easily. Next, the electrical component 13 is assembled to the second case member 50. In the remote controller main body 10, the electrical component 13 is fixed to the second case member 50 with screws.

Thereafter, the assembly of the cover panel 30 and the first case member 40 and the assembly of the electrical component 13 and the second case member 50 are assembled. At this time, the end portions 32A of the panel side portions 32 on the left and right sides of the cover panel 30 are inserted into the gaps 50A between the outer wall portions 52 and the inner wall portions 55 of the second case member 50. Thereby, the front end surfaces of the outer wall portions 52 are cause to abut against the steps of the panel side portions 32, and the outer surfaces of the panel side portions 32 on the distal end side are overlaid on the inner surfaces of the outer wall portions 52. As a result, the end portions 32A of the panel side portions 32, which are the end portions of the cover panel 30, are covered by the outer wall portions 52 as cover portions (see FIG. 4). In this state, the outer surface of the cover panel 30 and the outer surface of the second case member 50 are continuous without a step in the front-back direction.

By assembling the assembly of the cover panel 30 and the first case member 40 and the assembly of the electrical component 13 and the second case member 50 in this way, the side wall portions 42 of the first case member 40 are also inserted into the gaps 50A. Thereby, the front end surfaces of the inner wall portions 55 of the second case member 50 are caused to abut against the steps of the side wall portions 42, and the inner side surfaces of the side wall portions 42 are overlaid on the outer side surfaces of the inner wall portions 55 (see FIG. 4). As a result, the locking portions 46 and the locked portions 33 are sandwiched between the outer wall portions 52 and the inner wall portions 55 in the locked state. That is, in the assembled state of the assembly of the cover panel 30 and the first case member 40 and the assembly of the electrical component 13 and the second case member 50, it is difficult to release the locking of the locking portions 46 and the locked portions 33.

At this time, the upper and lower end wall portions 43 and 44 of the first case member 40 are inserted into the gaps 50B between the upper wall portion 53 and the upper inner end wall portion 56 of the second case member 50 and between the lower wall portion 54 and the lower inner wall portion 56 of the second case member 50. Thereby, the front end surfaces of the inner end wall portions 56 are caused to abut against the steps of the upper and lower end wall portions 43 and 44, and the inner surfaces of the end wall portions 43 and 44 and the outer surfaces of the inner end wall portions 56 are overlaid on each other (see FIG. 5). The upper wall portion 53 and the lower wall portion 54 cover the upper and lower end surfaces of the assembly of the cover panel 30 and the first case member 40. That is, the upper and lower end surfaces of the cover panel 30 and the upper and lower end surfaces of the first case member 40 are covered by the upper wall portion 53 and the lower wall portion 54, respectively.

Finally, the tapping screws 14 are inserted into the counterbores 51A and fastened (see FIG. 4). Then, the name plate 15 is affixed to the recessed portion 51B with a double-sided tape (see FIGS. 4 and 5), and the lid member 16 is fitted to the storage portion 51C (see FIG. 5), whereby the assembling of the remote controller main body 10 is completed.

As shown in FIG. 1, the remote controller main body 10 has a design with no irregularities or gaps on the front surface. The cover panel 30 having light permeability provides a design with a sense of depth. The curved surface of the outer surface of the cover panel 30 constituting the front surface is smoothly continuous with the curved surface of the outer surface of the second case member 50 constituting the back surface. As described above, the remote controller main body 10 as a whole realizes a slim and high-quality design.

When the toilet device is operated using the remote controller main body 10, the first operation unit 11 is operated. The first operation unit 11 employs electrostatic capacitance touch switches. By placing a finger at a position on the outer surface of the cover panel 30 corresponding to the first operation unit 11, the position is read and the operation of the toilet device is executed. As described above, the first operation unit 11 employs the electrostatic capacitance touch switches, and therefore, unlike the case where push button switches are employed, a flush shape with no irregularities on the outer surface can be adopted. When a finger or the like is placed on the first operation unit 11 and the touch switch detects the finger, the remote controller main body 10 can let a user know the detection by vibration of a vibration motor or the like.

As described above, the toilet remote controller 100 is a toilet remote controller for remotely operating the toilet device, and includes the remote controller main body 10. The remote controller main body 10 includes the case 20 that forms the storage space 20A that stores the electrical component 13, and the cover panel 30 that covers the case 20 with light permeability. According to this, a sense of depth can be given by the thickness from the outer surface to the inner surface of the cover panel 30.

Therefore, the toilet remote controller 100 can make the designability favorable.

The case 20 includes the first case member 40 and the second case member 50 to be combined with the first case member 40, and forms the storage space 20A that stores the electrical component 13. The cover panel 30 covers the outer surface of the first case member 40, and the second case member 50 includes the outer wall portions 52 that are cover portions that cover the end portions 32A of the panel side portions 32 that are the end portions of the cover panel 30. As a result, it is possible to achieve the configuration in which the first case member 40 is not exposed to the outside, so that the designability can be made more favorable.

The cover panel 30 includes the opaque region 30E whose outer surface has been subjected to embossing and the transparent region 30F. According to this, even if the regions have the same light permeability, the visual difference between transparent and opaque can be expressed, so that the designability can be made more favorable.

The cover panel 30 includes the first display unit 34 and the second display unit 35 serving as the display units that are provided on the inner surface thereof and on which at least one display of characters, figures, symbols, and patterns is formed. Therefore, it is possible to achieve the configuration in which the display is not exposed to the outer surface, although the display can be visually recognized from the outer surface. As a result, wear and disappearance of the display can be prevented, and deterioration in designability can be suppressed. Since the displays of the first display unit 34 and the second display unit 35 are respectively formed by the printing layers 30B, easy formation of the display units can be realized.

On the inner surface side of the cover panel 30, the second coating layer 30D that is a reflective layer is formed. Therefore, it is possible to prevent the portion inside the cover panel 30 from being seen through.

The panel side portions 32 that are the end portions of the cover panel 30 are formed to be curved in a form extending toward the second case member 50 side. Therefore, the designability can be made more favorable.

The outer surface of the cover panel 30 is formed in a smooth surface shape. Therefore, as compared with the case where irregularities are formed on the outer surface, the designability can be made more favorable.

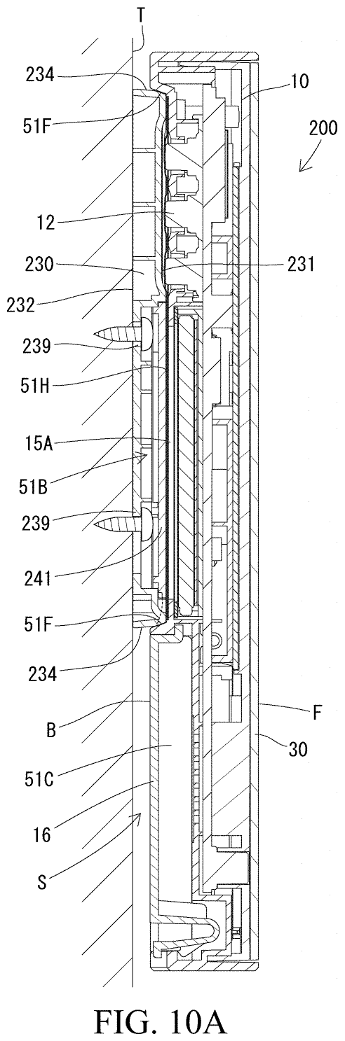

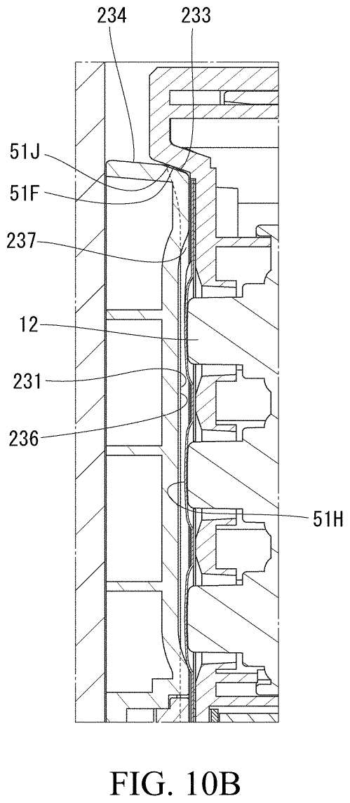

A toilet remote controller 200 in some embodiments is used to operate a toilet device (not shown). In some embodiments, the toilet remote controller 200 includes the remote controller main body 10. As described above, the remote controller main body 10 transmits an operation signal to the toilet device. The remote controller main body 10 is a portable type that can be carried. The toilet remote controller 200 includes a holder 230 that detachably holds the remote controller main body 10. The holder 230 is configured to be fixed to a mounting surface T. The remote controller main body 10 is provided with the recessed portion 51B where the holder 230 is located. The remote controller main body 10 is held on the holder 230 fixed to the mounting surface T under the state in which the recessed portion 51B is located on the holder 230. Hereinafter, in each component, a description will be given assuming that, in the state where the remote controller main body 10 is held on the holder 230 fixed to the mounting surface T (remote controller mounted state), the upper side (upper side in FIG. 10A) is an upside, the lower side (lower side in FIG. 10A) is a downside, the side facing the mounting surface T in the remote controller mounted state (left side in FIG. 10A) is a back side, and the opposite side (right side in FIG. 10A) is a front side.

The remote controller main body 10 has a size that can be operated with one hand. The remote controller main body 10 has a substantially rectangular plate shape that is long in the up-and-down direction. The dimensions of the remote controller main body 10 in the up-and-down direction and the left-and-right direction are larger than the dimensions of the holder 230 in the up-and-down direction and the left-and-right direction.

As shown in FIGS. 10A and 10B, a front surface F of the remote controller main body 10 (surface opposite to the mounting surface T in the remote controller mounted state) is a smooth surface with no irregularity, which is entirely covered with the cover panel 30 having light permeability.

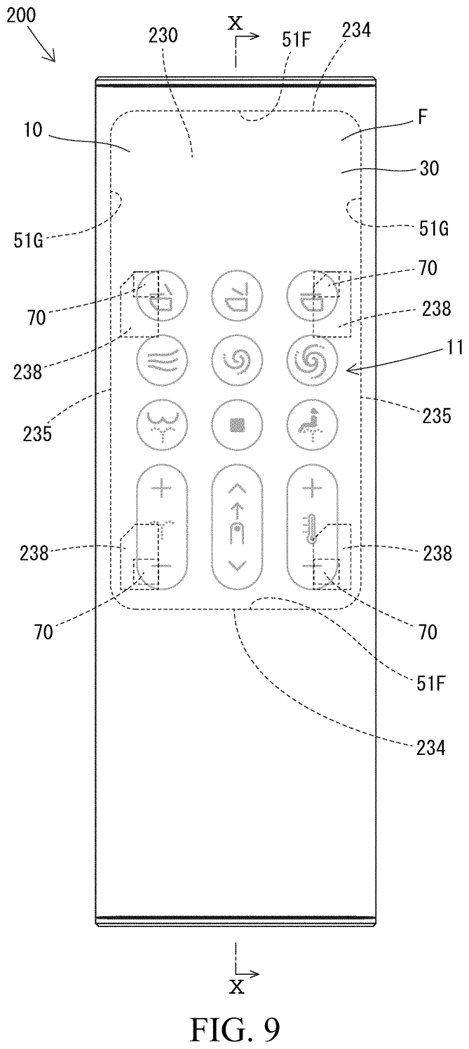

As shown in FIG. 9, the first operation unit 11 is provided on the front surface F of the remote controller main body 10. The first operation unit 11 has operation switches that are frequently used. The operation switches are operated when various functions of the toilet device are to be executed, and are for example, switches for toilet flushing, buttocks washing, toilet seat and toilet lid opening/closing operation, hot air drying, washing strength adjustment, nozzle position adjustment, and various-temperature adjustment. The first operation unit 11 employs electrostatic capacitance touch switches that react only by touching.

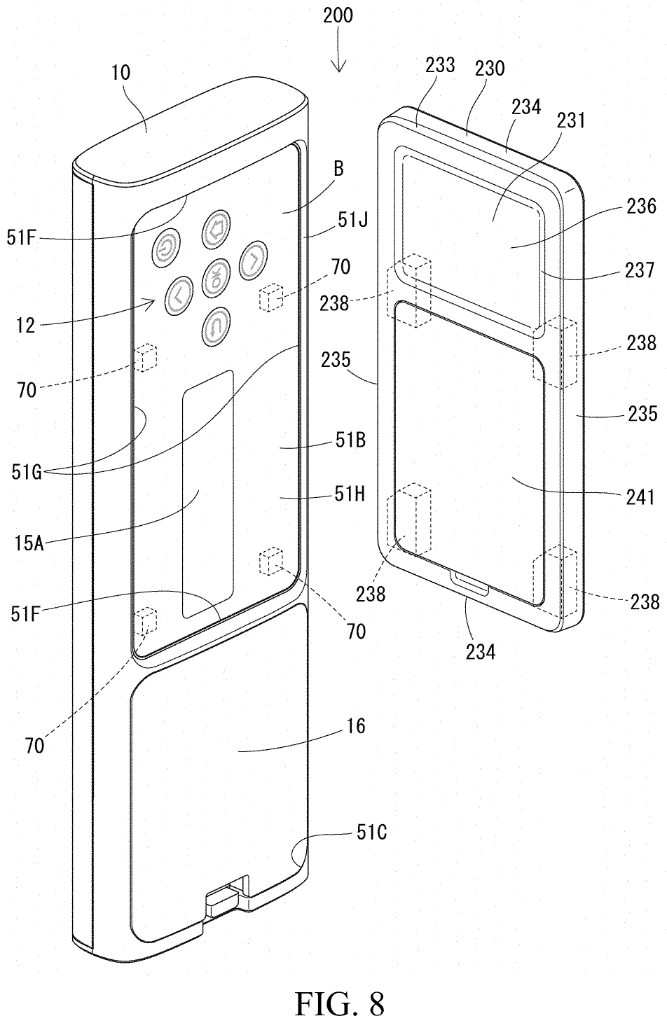

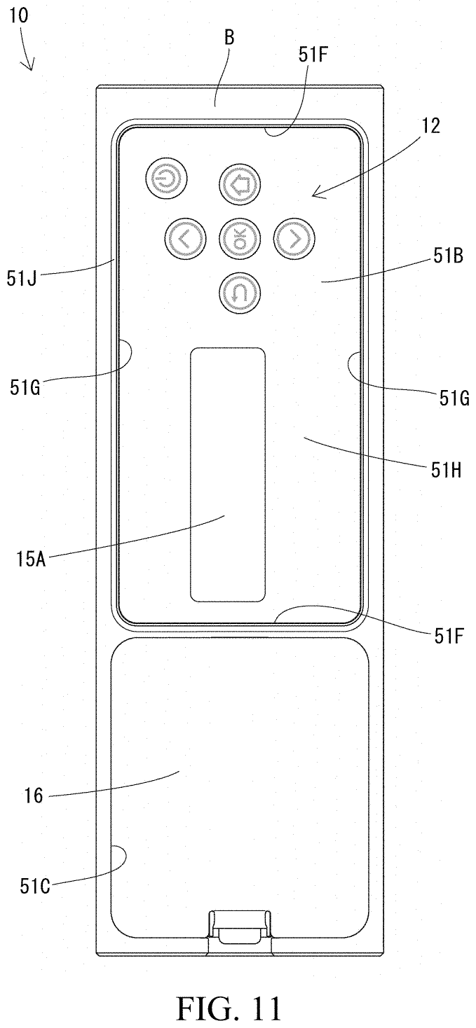

As shown in FIGS. 8 and 11, the recessed portion MB that is fitted to the holder 230 is provided on a back surface B of the remote controller main body 10. The size of the recessed portion 51B is formed larger than half of the length (dimension in the up-and-down direction) of the remote controller main body 10 and larger than half of the width (dimension in the left-and-right direction) of the remote controller main body 10. The recessed portion 51B is formed in a region approximately half or more of the upper side of the remote controller main body 10 (region corresponding to the first operation unit 11). The recessed portion 51B is a rectangular recess whose entire periphery is surrounded by the peripheral surfaces (upper and lower surfaces 51F and left and right surfaces 51G). A depth surface 51H of the recessed portion 51B is substantially parallel to the front surface F of the remote controller main body 10.

The upper and lower surfaces 51F and the left and right surfaces MG of the recessed portion 51B are provided with inclined portions 51J that guide the fitting operation between the recessed portion 51B and the holder 230. As shown in FIGS. 10A and 10B, the inclined portions 51J are inclined so that the distance between them increases from the depth surface 51H of the recessed portion 51B toward the back side (open side of the recessed portion 51B).

As shown in FIG. 11, the second operation unit 12 is provided on the back surface B of the remote controller main body 10. The second operation unit 12 has setting switches that are less frequently used. The setting switches are operated when the power source of the remote controller main body 10 is turned ON/OFF, when ON/OFF setting such as power saving and automatic cleaning is performed, and when time setting is performed. The second operation unit 12 employs press switches that are operated by a pressing operation. The back surface B of the remote controller main body 10 is provided with a third display unit 15A that displays a setting state and the like.

The second operation unit 12 and the third display unit 15A are provided on the depth surface 51H of the recessed portion 51B. The second operation unit 12 is arranged in the upper region of the depth surface 51H of the recessed portion 51B. The third display unit 15A is arranged in the lower region of the depth surface 51H of the recessed portion 51B.

As shown in FIG. 8, the remote controller main body 10 is provided with magnets (hereinafter referred to as main-body-side magnets 70) that fix the remote controller main body 10 and the holder 230. The main-body side magnets 70 are provided within the formation range of the recessed portion 51B. The main-body side magnets 70 are arranged at positions avoiding a dent portion 236 of the holder 230 described later. The main-body side magnets 70 are provided in a pair on left and right end portions of the lower end of the recessed portion 51B and in a pair on left and right sides of the intermediate portion in the up-and-down direction of the recessed portion 51B. In other words, the main-body side magnets 70 are arranged one by one near the corners of the third display unit 15A.

The remote controller main body 10 is provided with a vibration motor that vibrates when the first operation unit 11 is operated, and a three-axis sensor used for detecting the inclination of the remote controller main body 10. The storage portion 51C that stores a battery is provided in the lower portion of the remote controller main body 10 (part below the recessed portion 51B).

As shown in FIG. 8, the holder 230 has a rectangular shape that is substantially the same shape as the recessed portion 51B of the remote controller main body 10. The size of the holder 230 is formed larger than half of the length (dimension in the up-and-down direction) of the remote controller main body 10 and larger than half of the width (dimension in the left-and-right direction) of the remote controller main body 10. The holder 230 has a plate shape thinner than the remote controller main body 10. The holder 230 is entirely fitted in the recessed portion 51B. In other words, the size of the holder 230 in the surface direction (dimension in the up-and-down direction and dimension in the left-and-right direction) is smaller than the size of the depth surface 51H of the recessed portion 51B. The thickness dimension (dimension in the front-and-back direction) of the holder 230 is larger than the depth dimension (dimension in the front-and-back direction) of the recessed portion 51B, as shown in FIGS. 10A and 10B.

The holder 230 includes a front surface and a back surface that are substantially parallel to the mounting surface T in a state where the holder 230 is fixed to the mounting surface T (hereinafter referred to as a fixed state). The holder 230 includes outer peripheral surfaces (upper and lower surfaces 234 and left and right surfaces 235) that surround the outer peripheries of the front and back surfaces. As shown in FIGS. 10A and 10B, the upper and lower surfaces 234 and the left and right surfaces 235 of the holder 230 are provided with inclined portions 233 inclined at substantially the same gradient as the inclined portions 51J of the upper and lower surfaces 51F and the left and right surfaces 51G of the recessed portion 51B. The inclined portions 233 are formed at the front end portions of the upper and lower surfaces 234 and the left and right surfaces 235.

On the front surface 231 of the holder 230, as shown in FIG. 8, the dent portion 236 is formed in a portion opposed to the second operation unit 12 in the remote controller mounted state. The dent portion 236 has a rectangular shape extending over the upper region of the front surface 231 of the holder 230. The dent portion 236 has a size corresponding to the entire region where the second operation unit 12 is arranged. The dent portion 236 is surrounded by a step portion 237 on the entire periphery. The front surface 231 of the holder 230 is a flat surface except for the step portion 237.

As shown in FIG. 8, the holder 230 is provided with magnets (hereinafter referred to as holder-side magnets 238) that fix the remote controller main body 10 and the holder 230. Four holder-side magnets 238 are arranged at positions corresponding to the main-body side magnets 70. The holder-side magnets 238 each have a larger block shape than the main-body side magnets 70.

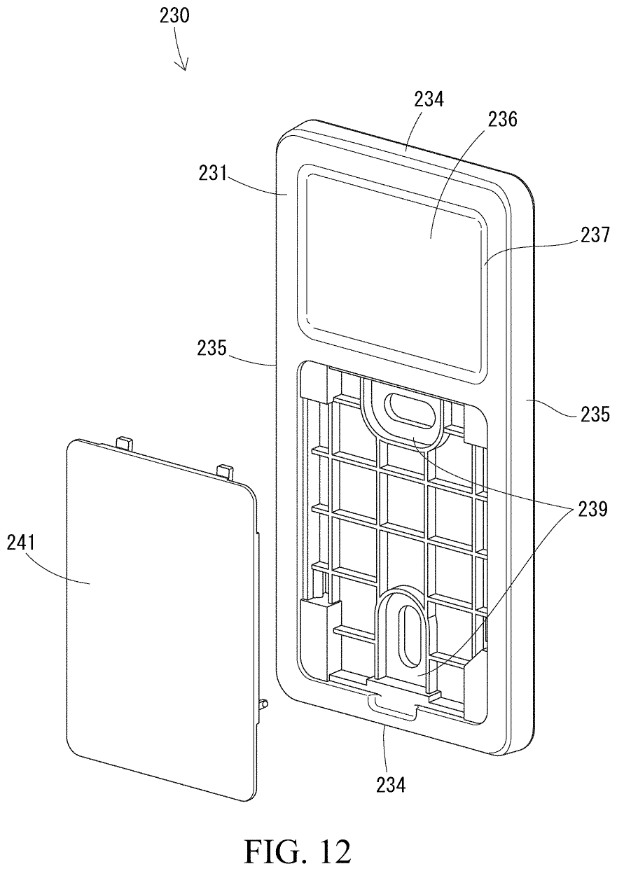

The holder 230 is provided with fixing portions 239 for fixing the holder 230 to the mounting surface T as shown in FIGS. 10A and 12. A screw hole is formed in each of the fixing portions 239. As shown in FIG. 12, the fixing portions 239 are provided in a region of the holder 230 below the dent portion 236. The fixing portions 239 are provided in a pair on upper and lower sides. The fixing portions 239 are covered with a lid member 241 that is detachable from the holder 230.

Next, the remote controller mounted state will be described. The upper and lower surfaces 234 of the holder 230 in the fixed state are generally horizontal in the left-and-right direction, and the left and right surfaces 235 of the holder 230 are generally vertical (see FIG. 9).

In the remote controller mounted state, the upper and lower surfaces 51F of the recessed portion 51B of the remote controller main body 10 and the upper and lower surfaces 234 of the holder 230 are arranged in contact with or close to each other. The upper and lower surfaces 51F of the recessed portion 51B and the upper and lower surfaces 234 of the holder 230 are positioning portions that position the remote controller main body 10 in the up-and-down direction with respect to the holder 230.

In the remote controller mounted state, the left and right surfaces 51G of the recessed portion 51B of the remote controller main body 10 and the left and right surfaces 235 of the holder 230 are arranged in contact with or close to each other. The left and right surfaces 51G of the recessed portion 51B and the left and right surfaces 235 of the holder 230 are positioning portions that position the remote controller main body 10 in the left-and-right direction with respect to the holder 230.

In the remote controller mounted state, the main-body side magnets 70 and the holder-side magnets 238 are close to each other. The remote controller main body 10 is fixed to the holder 230 without rattling by the magnetic force of the main-body side magnets 70 and the holder-side magnets 238.

As shown in FIGS. 10A and 10B, the front surface 231 of the holder 230 is arranged in contact with or close to the depth surface 51H of the recessed portion 51B except for the dent portion 236. As shown in FIG. 10B, in the dent portion 236, the front surface 231 of the holder 230 is arranged away from the depth surface 51H of the recessed portion 51B.

When the toilet remote controller 200 in the remote controller mounted state is viewed from the front side of the mounting surface T, the remote controller main body 10 covers the entire holder 230 as shown in FIG. 9. When the toilet remote controller 200 in the remote controller mounted state is viewed from the side surface side, a slight gap S is provided between the back surface B of the remote controller main body 10 and the mounting surface T as shown in FIG. 10A. The dimension of the gap S in the front and back direction is about half the thickness dimension (dimension in the front-and-back direction) of the holder 230.

Next, an example of an operation related to the use of the toilet remote controller 200 according to the second embodiment will be described. First, the remote controller main body 10 is removed from the holder 230. A user grips the remote controller main body 10 and moves it in a direction away from the holder 230. At this time, the user can remove the remote controller main body 10 from the holder 230 by moving it in a freely-selected direction. That is, the user can remove the remote controller main body 10 from the holder 230 by moving it in any direction, up, down, left, or right. At this time, the user can easily grip the region avoiding the first operation unit 11. That is, the user can easily grip the portion other than the recessed portion 51B provided at the position corresponding to the first operation unit 11. Since the second operation unit 12 is provided on the depth surface 51H of the recessed portion 51B, the user's fingers gripping the remote controller main body 10 are unlikely to press the second operation unit 12. Accordingly, it is possible to prevent an erroneous operation of the second operation unit 12 when the remote controller main body 10 is removed from the holder 230.

Next, the remote controller main body 10 is operated. The first operation unit 11 is touched to execute various functions of the toilet device such as toilet flushing and buttocks washing. At this time, the vibration motor vibrates, and the user can obtain tactile feedback. Various settings are performed by pressing the second operation unit 12. The operation of the second operation unit 12 is performed with the back surface B of the remote controller main body 10 facing upward and the remote controller main body 10 being held sideways. At this time, the three-axis sensor detects that the user is about to operate the second operation unit 12, and the first operation unit 11 becomes inoperable. Therefore, even if the user's finger touches the first operation unit 11, the first operation unit 11 can be prevented from being erroneously operated.

Next, the remote controller main body 10 is mounted to the holder 230. The recessed portion 51B is fitted to the holder 230 with the back surface B of the remote controller main body 10 facing the mounting surface T. At this time, the user can bring the remote controller main body 10 closer to the holder 230 in a freely-selected direction. That is, the user can bring the remote controller main body 10 closer to the holder 230 from any direction, up, down, left, and right. At this time, since the second operation unit 12 is provided on the depth surface 51H of the recessed portion 51B, the user's fingers gripping the remote controller main body 10 are unlikely to press the second operation unit 12. Accordingly, it is possible to prevent an erroneous operation of the second operation unit 12 when the remote controller main body 10 is mounted to the holder 230.

When the recessed portion 51B of the remote controller main body 10 is arranged at the position of the holder 230, the fitting between the recessed portion 51B and the holder 230 is guided by the inclined portions 51J of the recessed portion 51B and the inclined portions 233 of the holder 230. At the same time as the recessed portion 51B and the holder 230 are fitted, the main-body side magnets 70 and the holder-side magnets 238 are close to each other, and the remote controller main body 10 is fixed by the magnetic force of the main-body side magnets 70 and the holder-side magnets 238. Thus, a series of operations related to the use of the toilet remote controller 200 is completed.

The toilet remote controller 200 according to some embodiments is a toilet remote controller used to operate the toilet device. The toilet remote controller 200 includes the remote controller main body 10 that transmits an operation signal to the toilet device, and the holder 230 that is fixed to the mounting surface T and detachably holds the remote controller main body 10. The remote controller main body 10 is provided with the recessed portion 51B. The remote controller main body 10 is held on the holder 230 in a state where the holder 230 is fitted in the recessed portion 51B. According to this configuration, since the gap S between the mounting surface T and the remote controller main body 10 can be reduced, the amount of protrusion from the mounting surface T of the toilet remote controller 200 can be reduced in the remote controller mounted state.

The toilet remote controller 200 includes the main-body side magnets 70 and the holder-side magnets 238 that fix the remote controller main body 10 and the holder 230. According to this configuration, since the remote controller main body 10 is held on the holder 230 by the magnetic force, the holding force can be secured.

In the toilet remote controller 200, in the remote controller mounted state, the upper and lower surfaces 51F of the recessed portion 51B and the upper and lower surfaces 234 of the holder 230 are positioning portions that position the remote controller main body 10 and the holder 230 in the up-and-down direction. According to this configuration, since the remote controller main body 10 is positioned with respect to the holder 230 by fitting the recessed portion 51B of the remote controller main body 10 to the holder 230, the operation for mounting the remote controller main body 10 to the holder 230 can be easily performed.

The toilet remote controller 200 has a size that covers the entirety of the holder 230 when the remote controller main body 10 in the remote controller mounted state is viewed from the front side of the mounting surface T. According to this configuration, since the holder 230 cannot be seen from the front side of the mounting surface T in the remote controller mounted state, the appearance of the remote controller mounted state can be improved.

In the toilet remote controller 200, the second operation unit 12 is provided in the recessed portion 51B. According to this configuration, when the remote controller main body 10 is attached/detached to/from the holder 230, it is difficult for a hand to touch the operation unit, and thus an unintended operation of the second operation unit 12 can be prevented.

The remote controller main body 10 is provided with the second operation unit 12 on the back surface B, and the holder 230 has the dent portion 236 formed in a region opposed to the second operation unit 12 in the remote controller mounted state. According to this configuration, since the holder 230 does not come into contact with the second operation unit 12 of the remote controller main body 10 in the remote controller mounted state, the contact between the holder 230 and the second operation unit 12 can be prevented.

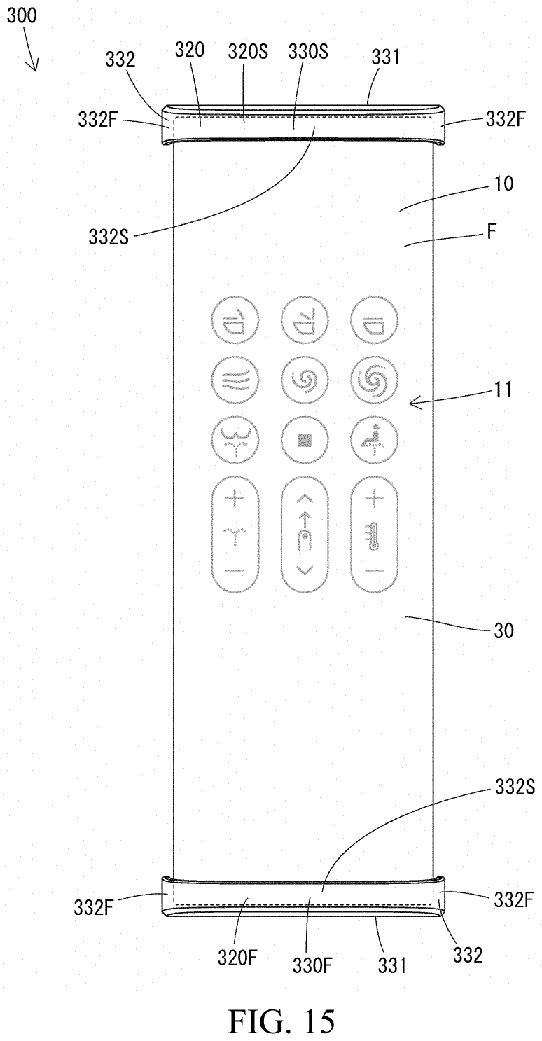

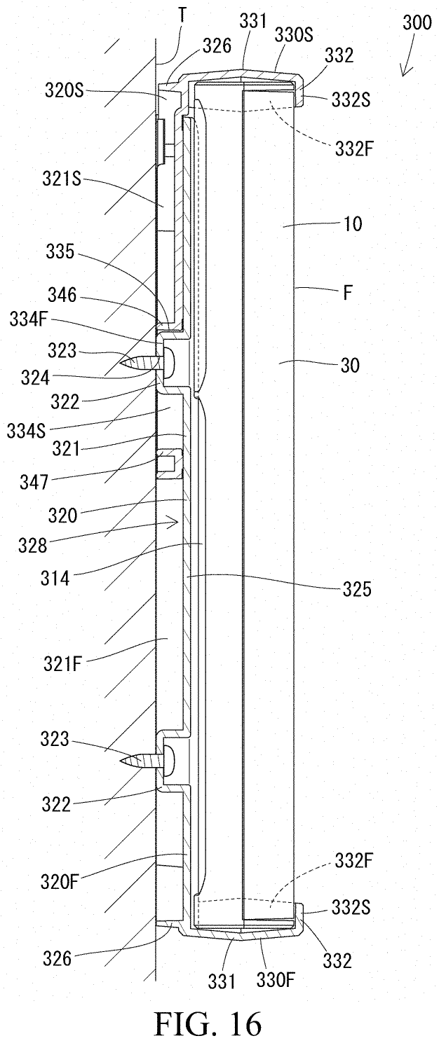

A toilet remote controller 300 in the third embodiment is used to operate a toilet device (not shown). The toilet remote controller 300 includes the remote controller main body 10 according to some embodiments. As described above, the remote controller main body 10 transmits an operation signal to the toilet device. The remote controller main body 10 is a portable type that can be carried. The toilet remote controller 300 includes a holder 320 that holds the remote controller main body 10. The holder 320 is configured to be fixed to the mounting surface T. Hereinafter, in each component, a description will be given assuming that, in the state where the remote controller main body 10 is held on the holder 320 fixed to the mounting surface T (remote controller mounted state), the upper side (upper side in FIG. 15) is an upside, the lower side (lower side in FIG. 15) is a downside, the side facing the mounting surface T in the remote controller mounted state (left side in FIG. 16) is a back side, and the opposite side (right side in FIG. 16) is a front side.

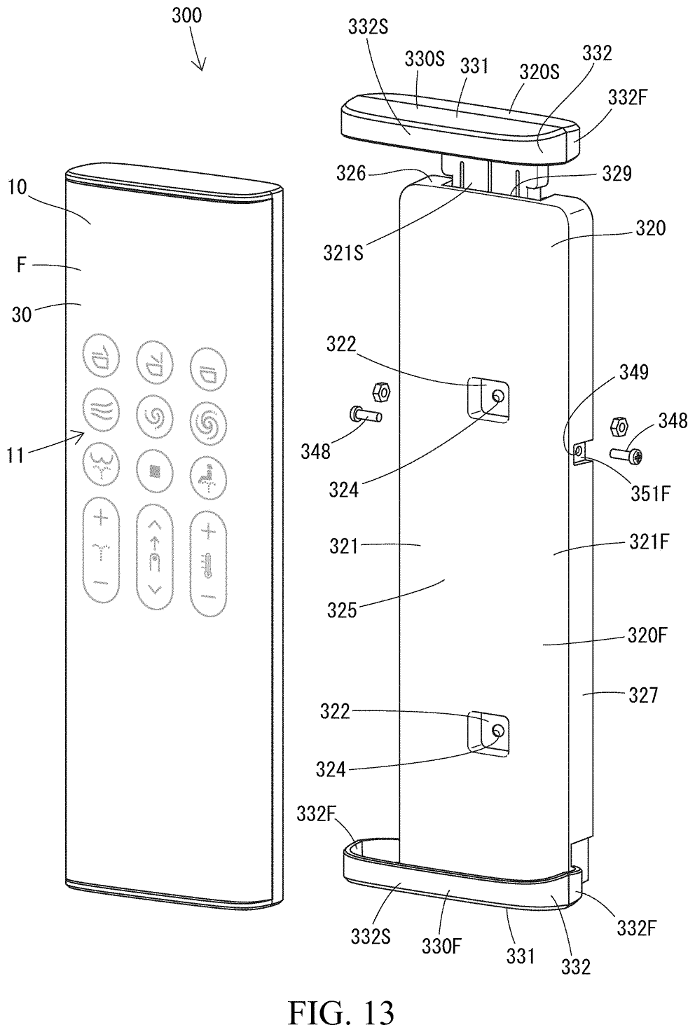

The remote controller main body 10 has a size that can be operated with one hand. The remote controller main body 10 has a substantially rectangular plate shape that is long in the up-and-down direction. The front surface F of the remote controller main body 10 (surface opposite to the mounting surface T in the remote controller mounted state) is a smooth surface with no irregularity, which is entirely covered with the cover panel 30 having light permeability. As shown in FIG. 13, the first operation unit 11 is provided on the front surface F of the remote controller main body 10. The first operation unit 11 has operation switches that are frequently used. The operation switches are operated when various functions of the toilet device are executed, and are for example, switches for toilet flushing (large and small), buttocks washing, toilet seat and toilet lid opening/closing operation, hot air drying, washing strength adjustment, nozzle position adjustment, and various-temperature adjustment. The first operation unit 11 employs electrostatic capacitance touch switches that react only by touching.

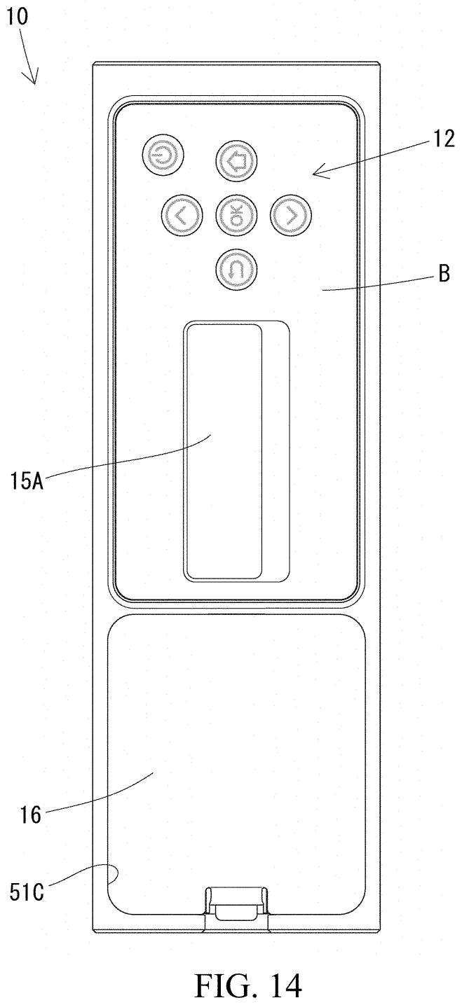

As shown in FIG. 14, the back surface B (surface of the remote controller main body 10 facing the mounting surface T) of the remote controller main body 10 is provided with the second operation unit 12. The second operation unit 12 has setting switches that are less frequently used. The setting switches are operated when the power source of the remote controller main body is turned ON/OFF, when ON/OFF setting such as power saving and automatic cleaning is performed, and when time setting is performed. The second operation unit 12 employs press switches that are operated by a pressing operation. The back surface B of the remote controller main body 10 is provided with a third display unit 15A that displays a setting state and the like.

The remote controller main body 10 is provided with a vibration motor that vibrates when the first operation unit 11 is operated, and an acceleration sensor (three-axis sensor) used for detecting the inclination of the remote controller main body 10. The storage portion 51C that stores a battery is provided in a lower portion of the remote controller main body 10.

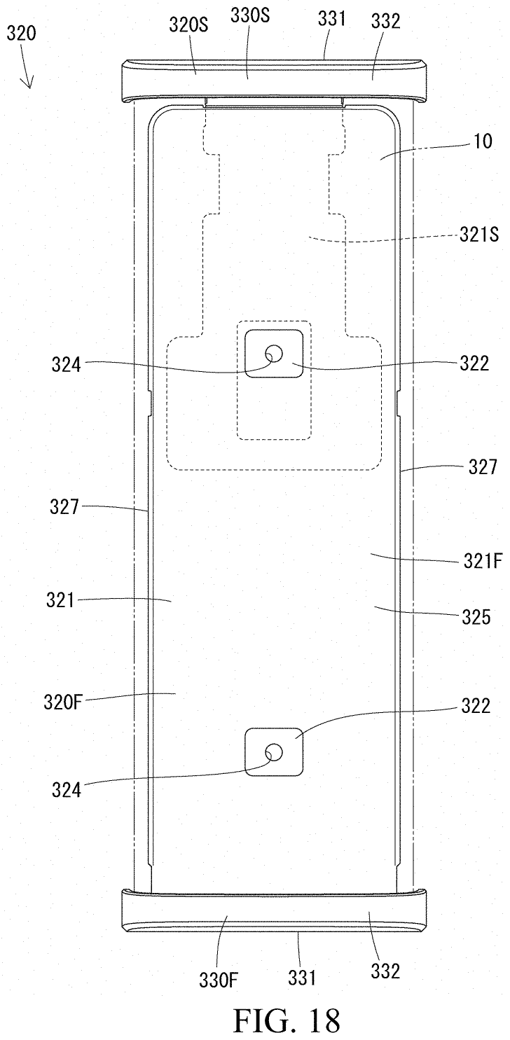

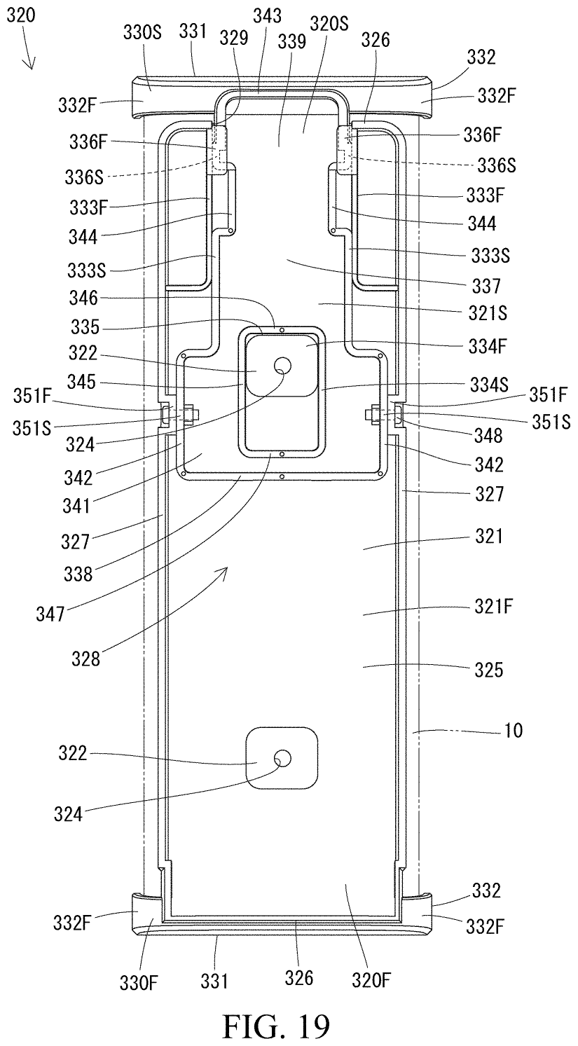

As shown in FIG. 13, the holder 320 has a substantially rectangular plate shape that is long in the up-and-down direction as a whole. The dimension of the holder 320 in the up-and-down direction is larger than the dimension of the remote controller main body 10 in the up-and-down direction. The holder 320 includes a main body portion 321 having a rectangular plate shape that is long in the up-and-down direction, and a pair of holding portions 330F and 330S provided at upper and lower end portions of the main body portion 321. The dimension of the main body portion 321 in the left-and-right direction is smaller than the dimension of the remote controller main body 10 in the left-and-right direction (see FIGS. 18 and 19).

As shown in FIG. 16, the main body portion 321 is provided with holder fixing portions 322 that are fixed to the mounting surface T. The holder fixing portions 322 are provided in a pair on upper and lower sides. The holder fixing portions 322 each have a shape protruding to the back side. The back surfaces (protruding end surfaces) of the holder fixing portions 322 are close to or in contact with the mounting surface T. Through holes 324 through which fixing screws 323 pass are formed on the back surfaces of the holder fixing portions 322. On the front sides of the holder fixing portions 322, recesses are formed on the front surface of the main body portion 321. As shown in FIG. 13, the holder fixing portions 322 are located approximately at the center of the main body portion 321 in the left-and-right direction. The front surface of the main body portion 321 is a flat surface except for the holder fixing portions 322.

The pair of holding portions 330F and 330S are a first holding portion 330F arranged on the lower side and a second holding portion 330S arranged on the upper side. The pair of holding portions 330F and 330S restrict the movement of the remote controller main body 10 in the up-and-down direction (one direction along the mounting surface T) with the remote controller main body 10 interposed therebetween.

Each of the first holding portion 330F and the second holding portion 330S has a cap shape that covers the end portion of the remote controller main body 10. The first holding portion 330F and the second holding portion 330S cover only end portions of the remote controller main body 10. Therefore, in the remote controller mounted state, most of the remote controller main body 10 is exposed to the outside.

The first holding portion 330F and the second holding portion 330S include end wall portions 331 that cover upper and lower end surfaces of the remote controller main body 10, and peripheral wall portions 332 that cover the peripheral surfaces of the end portions of the remote controller main body 10. The end wall portions 331 have the same shape as the upper and lower end surfaces of the remote controller main body 10. The end wall portions 331 stand substantially perpendicular to the front surface of the main body portion 321. The peripheral wall portions 332 stand substantially perpendicular to the end wall portions 331 along the outer edge of the end wall portions 331. The height dimensions (dimension in the up-and-down direction) of the peripheral wall portions 332 are the same over the peripheral direction.

The peripheral wall portions 332 each constitute first restriction portions 332F and a second restriction portion 332S that are opposed to the peripheral surface (outer surface) of the remote controller main body 10 and restrict the movement of the remote controller main body 10. As shown in FIG. 15, the first restriction portions 332F are left and right end portions of the peripheral wall portion 332 (portions standing along the left and right edges of the end wall portion 331). The first restriction portions 332F are opposed to left and right surfaces of the remote controller main body 10 and restrict the movement in the left-and-right direction (another direction that intersects one direction along the mounting surface T). The height dimensions of the first restriction portions 332F are dimensions capable of being locked to the left and right surfaces of the remote controller main body 10 to prevent the remote controller main body 10 from being detached.

As shown in FIGS. 15 and 16, the second restriction portions 332S are front side end portions of the peripheral wall portions 332 (portions standing along the front side edges of the end wall portions 331). The second restriction portions 332S are opposed to the front surface F of the remote controller main body 10 and restrict movement in the front direction (direction perpendicular to the mounting surface T). The height dimensions of the second restriction portions 332S are dimensions capable of being locked to the outer surface of the remote controller main body 10 to prevent the remote controller main body 10 from being detached.

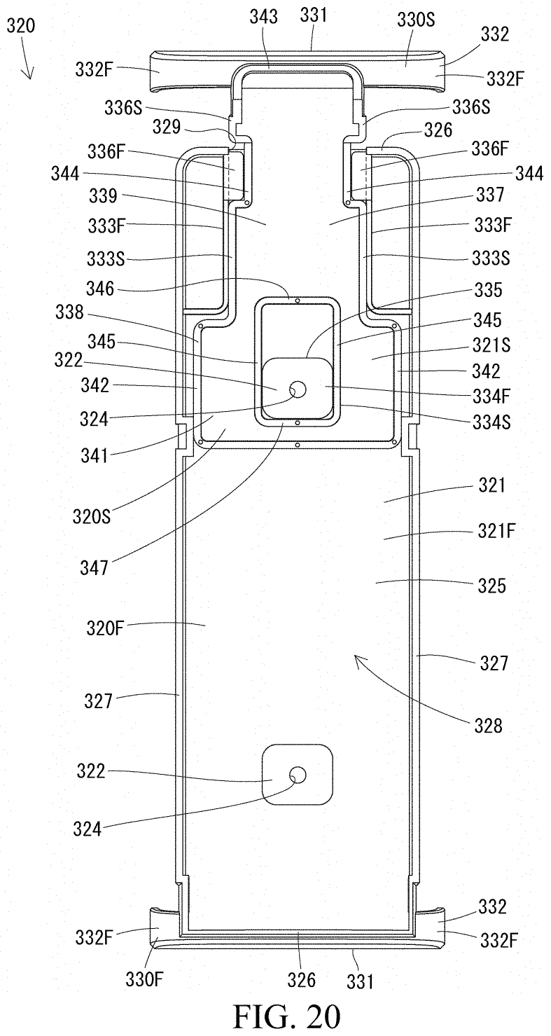

The holder 320 includes a first member 320F and a second member 320S that slide relative to each other in the up-and-down direction (see FIGS. 19 and 20). The first member 320F is fixed to the mounting surface T. The second member 320S slides in the up-and-down direction relative to the first member 320F. The first holding portion 330F is provided on the first member 320F, and the second holding portion 330S is provided on the second member 320S. The pair of holding portions 330F and 330S are movable in the approaching direction and the separating direction.

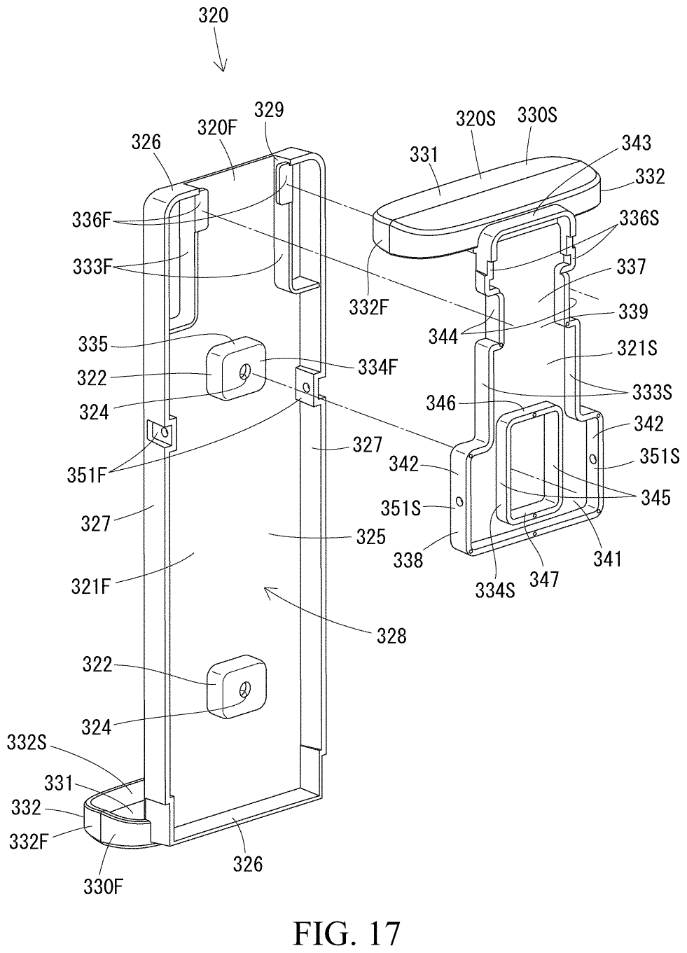

As shown in FIG. 17, the first member 320F includes a first main body portion 321F having the entire front surface of the body portion 321. The first main body portion 321F includes a front surface portion 325 constituting the front surface of the body portion 321, upper and lower surface portions 326 constituting upper and lower surfaces of the body portion 321, and left and right surface portions 327 constituting the left and right surfaces of the body portion 321. The upper and lower surface portions 326 and the left and right surface portions 327 stand on the back side from the outer edge of the front surface portion 325. On the back surface of the first main body portion 321F, a recessed portion 328 surrounded by the upper and lower surface portions 326 and the left and right surface portions 327 is formed. The upper surface portion 326 is formed with a cutout portion 329 for allowing a second main body portion 321S described later of the second member 320S to protrude upward.

As shown in FIGS. 19 and 20, the back surface of the first main body portion 321F is provided with first guide portions 333F that guide the sliding movement between the first member 320F and the second member 320S. The first guide portions 333F are provided on the left and right sides of the upper end portion of the first main body portion 321F. Each of the first guide portions 333F has a plate shape standing perpendicular to the front surface portion 325. The pair of left and right first guide portions 333F extends in the up-and-down direction substantially in parallel. The first guide portions 333F are separated from the left and right surface portions 327.

As shown in FIGS. 19 and 20, the back surface of the first main body portion 321F is provided with a first stopper portion 334F that restricts the sliding movement between the first member 320F and the second member 320S. The first stopper portion 334F is protrudingly provided in the upper region of the front surface portion 325. The first stopper portion 334F has a stopper peripheral surface 335 having a square shape.

As shown in FIG. 19, a second stopper portion 334S described later comes into contact with the upper surface of the stopper peripheral surface 335, so that the downward movement of the second member 320S is restricted. As shown in FIG. 20, the second stopper portion 334S comes into contact with the lower surface of the stopper peripheral surface 335, so that the upward movement of the second member 320S is restricted. The first stopper portion 334F also serves as the holder fixing portion 322.

As shown in FIG. 19, the back surface of the first main body portion 321F is provided with first locking portions 336F to be locked to the second member 320S. As shown in FIG. 17, the first locking portions 336F each have a plate shape extending from the back side end of the first guide portion 333F in a direction parallel to the front surface portion 325. The first locking portions 336F are locked to the back side of the second member 320S, so that the assembled state of the first member 320F and the second member 320S is maintained.

The first holding portion 330F is provided at the lower end portion of the first main body portion 321F. The outer peripheral edge of the end wall portion 331 of the first holding portion 330F is surrounded on the entire periphery by the peripheral wall portion 332 and the first main body portion 321F.

The second member 320S includes the second main body portion 321S to be arranged in the recessed portion 328 of the first main body portion 321F. The dimension of the second main body portion 321S in the up-and-down direction is about half of the dimension of the first main body portion 321F in the up-and-down direction.

The second main body portion 321S includes a back surface portion 337 to be arranged along the front surface portion 325 of the first main body portion 321F, and a peripheral surface portion 338 standing along the outer edge of the back surface portion 337. The back surface portion 337 includes a small-width portion 339 having a small dimension in the left-and-right direction and a large-width portion 341 having a large dimension in the left-and-right direction. The small-width portion 339 is located above the large-width portion 341. The dimension of the small-width portion 339 in the left-and-right direction is a dimension capable of passing through the cutout portion 329 of the upper surface portion 326 of the first member 320F in the up-and-down direction.

The rising dimension (dimension in the front-and-back direction) of the peripheral surface portion 338 is such a dimension that the end surface on the back side of the peripheral surface portion 338 is aligned with the end surfaces on the back side of the upper and lower surface portions 326 and the left and right surface portions 327 of the first main body portion 321F. The peripheral surface portion 338 includes a pair of left and right side surface portions 342 extending along the left and right surface portions 327 of the first main body portion 321F, and a pair of left and right second guide portions 333S extending along the first guide portions 333F. The side surface portions 342 extend along the left and right side edges of the large-width portion 341, and the second guide portions 333S extend along the left and right side edges of the small-width portion 339.

The left and right second guide portions 333S come into contact with the first guide portions 333F and guide the movement of the second member 320S in the up-and-down direction relative to the first member 320F. The upper end portions of the pair of left and right second guide portions 333S protrude upward from the cutout portion 329 of the upper surface portion 326 of the first member 320F. The second holding portion 330S is fixed to a bridge portion 343 that is laid between the upper ends of the left and right second guide portions 333S. The peripheral wall portion 332 of the second holding portion 330S has a form in which the entire periphery is closed.

The second member 320S includes second locking portions 336S to which the first locking portions 336F are locked as shown in FIG. 19, and relief portions 344 to which the first locking portions 336F are not locked as shown in FIG. 20. The second locking portions 336S and the relief portions 344 are provided in the second guide portions 333S. The relief portions 344 are provided at positions corresponding to the first locking portions 336F when the pair of holding portions 330F and 330S are arranged at the most distant positions in the assembled state of the first member 320F and the second member 320S. The relief portions 344 each have such a form that a part of the second guide portion 333S has a shape along the outer shape of the first locking portion 336F and is recessed to the center side in the left-and-right direction. The second locking portions 336S are provided above the relief portions 344.

As shown in FIGS. 19 and 20, the second member 320S is provided with the second stopper portion 334S that comes into contact with the first stopper portion 334F of the first member 320F and restrict the sliding movement between the first member 320F and the second member 320S. The second stopper portion 334S has a substantially square frame shape that is fitted around the first stopper portion 334F. The second stopper portion 334S includes a pair of side portions 345 that are substantially parallel to each other, and an upper portion 346 and a lower portion 347 that are substantially parallel to each other. The pair of side portions 345 comes into contact with the left and right side surfaces of the stopper peripheral surface 335 of the first stopper portion 334F and guide the sliding movement between the first member 320F and the second member 320S. The upper portion 346 and the lower portion 347 come into contact with the upper surface and the lower surface of the stopper peripheral surface 335, respectively, and restrict the sliding movement between the first member 320F and the second member 320S.

The holder 320 includes fixing tools 348 that restrict sliding movement between the first member 320F and the second member 320S. As shown in FIG. 19, the fixing tools 348 fix the first member 320F and the second member 320S in a state where the pair of holding portions 330F and 330S are closest to each other. That is, the fixing tools 348 restrict the movement of the pair of holding portions 330F and 330S in the separating direction. The fixing tools 348 are screws and nuts for fixing the left and right surface portions 327 of the first main body portion 321F and the side surface portions 342 of the second main body portion 321S.

The left and right surface portions 327 of the first member 320F are provided with first member fixing portions 351F that are fixed with the side surface portions 342 of the second member 320S by the fixing tools 348. The side surface portions 342 of the second member 320S are provided with second member fixing portions 351S that are fixed to the left and right surface portions 327 of the first member 320F by the fixing tools 348. The first member fixing portions 351F and the second member fixing portions 351S are arranged at positions that coincide with each other on the left and right in the state of being slid. The first member fixing portions 351F and the second member fixing portions 351S are formed with through holes penetrating in the left-and-right direction. The first member fixing portions 351F are provided at positions that are advanced one step to the center side in the left-and-right direction.

Next, an example of an operation for mounting the toilet remote controller 300 to the mounting surface T will be described. First, the first member 320F and the second member 320S are assembled. As shown in FIG. 17, the first locking portions 336F of the first member 320F and the relief portions 344 of the second member 320S are aligned, and the second main body portion 321S of the second member 320S is fitted into the recessed portion 328 of the first member 320F. Next, the first member 320F and the second member 320S are slid, and as shown in FIG. 18, the first locking portions 336F are shifted from the relief portions 344 and locked to the second locking portions 336S. At this time, the first guide portions 333F and the second guide portions 333S are brought into contact with each other, and the sliding movement between the first member 320F and the second member 320S is guided. When the first locking portions 336F are locked to the second locking portions 336S, the first member 320F and the second member 320S are held in the assembled state.

Next, the holder 320 is fixed to the mounting surface T. The back surface of the holder 320 is brought into contact with the mounting surface T in such a direction that the first holding portion 330F is arranged on the lower side and the second holding portion 330S is arranged on the upper side. Due to the weight of the second member 320S, the upper portion 346 of the second stopper portion 334S comes into contact with the stopper peripheral surface 335 of the first stopper portion 334F, and the assembled state of the first member 320F and the second member 320S is maintained. The screws 323 are passed through the through holes 324 of the holder fixing portions 322 from the front side of the holder 320 to fix the holder fixing portions 322 to the mounting surface T. As a result, the holder 320 is fixed to the mounting surface T.

Next, the remote controller main body 10 is set in the holder 320. The second member 320S is slid upward to open between the pair of holding portions 330F and 330S. The lower end portion of the remote controller main body 10 is fitted into the first holding portion 330F, and the back surface B of the remote controller main body 10 is aligned with the front surface of the main body portion 321 of the holder 320. The end wall portion 331 of the first holding portion 330F supports the lower surface of the remote controller main body 10, and the peripheral wall portion 332 of the first holding portion 330F covers the outer peripheral surface of the lower end portion of the remote controller main body 10. The second member 320S is slid downward, and the second holding portion 330S is placed on the upper end portion of the remote controller main body 10. The upper portion 346 of the second stopper portion 334S of the second member 320S comes into contact with the stopper peripheral surface 335 of the first stopper portion 334F, and the sliding movement of the second member 320S stops. The end wall portion 331 of the second holding portion 330S is in contact with or close to the upper surface of the remote controller main body 10, and the peripheral wall portion 332 of the second holding portion 330S covers the outer peripheral surface of the upper end portion of the remote controller main body 10. The first member fixing portions 351F and the second member fixing portions 351S are fixed by the fixing tools 348, and the movement of the pair of holding portions 330F and 330S in the separating direction is restricted.

The remote controller main body 10 is sandwiched between the pair of holding portions 330F and 330S and is restricted from moving in the up-and-down direction. The movement in the left-right direction is restricted by the first restriction portions 332F provided in the holding portions 330F and 330S, and the movement in the front direction is restricted by the second restriction portions 332S provided in the holding portions 330F and 330S. As a result, the remote controller main body 10 is held in the state set in the holder 320. Thus, the operation of mounting the toilet remote controller 300 to the mounting surface T is completed.

Next, functions and effects configured as described above will be described. The toilet remote controller 300 according to some embodiments is a toilet remote controller used to operate the toilet device, and includes the remote controller main body 10 that transmits an operation signal to the toilet device, and the holder 320 that is configured to be fixed to the mounting surface T and holds the remote controller main body 10. The holder 320 includes the pair of holding portions 330F and 330S that restrict the movement of the remote controller main body 10 in the up-and-down direction with the remote controller main body 10 interposed therebetween. The holding portions 330F and 330S include the first restriction portions 332F that restrict movement of the remote controller main body 10 in the left-and-right direction and the second restriction portions 332S that restrict movement of the remote controller main body 10 in the front direction.

In some embodiments, the movement of the remote controller main body 10 in the up-and-down direction is restricted by the pair of holding portions 330F and 330S. The movement of the remote controller main body 10 in the left-right direction is restricted by the first restriction portions 332F provided in the holding portions 330F and 330S, and the movement of the remote controller main body 10 in the front direction is restricted by the second restriction portions 332S provided in the holding portions 330F and 330S. Therefore, it is possible to prevent the remote controller main body 10 from being easily removed from the holder 320 without fixing the remote controller main body 10 with screws.

The holding portions 330F and 330S each have a shape that covers the end portion of the remote controller main body 10, and the first restriction portions 332F and the second restriction portions 332S are opposed to the outer surface of the remote controller main body 10 and restrict the movement of the remote controller main body 10. According to this configuration, it is not necessary to provide the remote controller main body 10 and the holder 320 with a recess and a projection that are fitted to each other as the first restriction portions 332F and the second restriction portions 332S. Therefore, the appearance of the remote controller main body 10 can be improved.

The holder 320 includes the pair of members 320F and 320S that are slidable in the up-and-down direction. The first member 320F of the pair of members 320F and 320S is provided with the first holding portion 330F of the pair of holding portions 330F and 330S. The second member 320S of the pair of members 320F and 320S is provided with the second holding portion 330S of the pair of holding portions 330F and 330S. The pair of holding portions 330F and 330S are movable in the approaching direction and the separating direction. According to this configuration, the pair of holding portions 330F and 330S are moved in the separating direction and the remote controller main body 10 can be set therebetween, and the pair of holding portions 330F and 330S are moved in the approaching direction and the remote controller main body 10 can be sandwiched therebetween. Thus, the mounting operation of the remote controller main body 10 can be easily performed.

The fixing tools 348 that restrict the movement of the pair of members 320F and 320S in the separating direction are provided. According to this configuration, the movement of the pair of members 320F and 320S in the separating direction is reliably restricted by the fixing tools 348, so that the holding state of the remote controller main body 10 can be reliably maintained.

The second operation unit 12 is provided on the back surface B of the remote controller main body 10. According to this configuration, the second operation unit 12 cannot be operated in the state where the remote controller main body 10 is held on the holder 320. Therefore, by using the second operation unit 12 as an operation unit for performing various settings of the toilet device as in some embodiments, it is possible to prevent various settings from being arbitrarily changed in a place where the toilet device is used by an unspecified number of people.

The present disclosure is not limited to the disclosure of the embodiments described with reference to the above description and drawings, and includes the following embodiments, for example.

In some embodiments, the form in which the remote controller has a specific outer shape is exemplified. The shape of the toilet remote controller according to the present disclosure is not particularly limited, and may be various shapes such as three-dimensional shapes such as a circular columnar shape, a polygonal columnar shape, a spherical shape, and an oval spherical shape, or three-dimensional shapes that partially combines these shapes.

In some embodiments, the form in which the remote controller is provided so as to be attachable to and detachable from the holder mounted to the wall surface is exemplified. The toilet remote controller according to the present disclosure may be mounted on the wall surface in a non-detachable manner, or may be an independent portable type that is not mounted on a holder or the like.

In some embodiments, the form in which each member of the remote controller is formed using a specific material is exemplified. In the toilet remote controller according to the present disclosure, materials used for each member are not limited to those described above.

In some embodiments, the form in which the case includes the first case member and the second case member is exemplified. The case according to the present disclosure may be configured by one member or may be configured by three or more members.

In some embodiments, the form in which the cover panel includes the opaque region and the transparent region is exemplified. This is not essential. In the present disclosure, the cover panel may have a form including only an opaque region having light permeability or may have a form including only a transparent region. In forming the opaque region, other surface treatments instead of embossing may be employed, or the opaque region may be provided by forming other layers, such as attaching a sheet material or applying a coating.

In some embodiments, the form in which the display unit is formed by printing is exemplified. In the case of forming the display unit, it may be formed by means other than printing, such as sticking of a sheet or painting. The display content of the display unit is not limited to that which is described above.

In some embodiments, the form in which the silver color coating film is formed as the reflective layer is exemplified. The reflective layer according to the present disclosure may be in other forms, such as metal plating or metal vapor deposition.

In some embodiments, the form in which the locking portions are claw portions and the locked portions are hole portions are exemplified. The opposite configuration, a configuration in which a claw portion and a hole portion are mixed in one member, or the like may be employed. The locking form is not limited to the snap-fit structure, and other forms may be adopted.

In some embodiments, the form in which the cover panel covers the case from the front surface to the side surfaces is exemplified. The cover panel according to the present disclosure is not limited to this. For example, the cover panel may be in a form covering only the front surface of the case.

In some embodiments, the form in which the cover panel covers the case being provided also for a portion other than the portion corresponding to the first operation unit serving as the operation unit is exemplified. It may be a form in which the cover panel covers only a part of the case, such as a form in which the cover panel covers the case being provided only for the portion corresponding to the operation unit.

In some embodiments, the entire periphery of the recessed portion is surrounded by the peripheral surface. The present disclosure is not limited to this, but for example, the left and right sides of the recessed portion may be opened.

In some embodiments, the recessed portion and the holder both have a rectangular shape. The present disclosure is not limited to this, but it is only necessary that the recessed portion and the holder can be fitted to each other. For example, the recessed portion and the holder both may have a circular shape, or may have different shapes, such as a rectangular shape in one and a trapezoidal shape in the other.

In some embodiments, the remote controller main body and the holder are fixed by the main-body side magnets and the holder-side magnets. The present disclosure is not limited to this, but other fixing means may be used. Without using such fixing means, the remote controller main body may be held on the holder only by the fitting between the recessed portion and the holder (for example, by increasing the fitting allowance (fitting depth) between the recessed portion and the holder).

In some embodiments, the entire holder is fitted in the recessed portion. The present disclosure is not limited to this, but the holder may include a fitting portion with the recessed portion and a portion extending from the fitting portion in a direction parallel to the mounting surface (a portion not covered by the remote controller main body when viewed from the front side of the mounting surface in the remote controller mounted state).

In some embodiments, the upper and lower surfaces of the recessed portion and the upper and lower surfaces of the holder are configured to position the remote controller main body in the up-and-down direction with respect to the holder. The present disclosure is not limited to this, but the upper and lower surfaces of the recessed portion and the upper and lower surfaces of the holder may not necessarily have such a positioning function.

In some embodiments, the remote controller main body has a size that covers the entire holder when the remote controller main body in the remote controller mounted state is viewed from the front side of the mounting surface. The present disclosure is not limited to this, but the remote controller main body may have a size that partially covers the holder.

In some embodiments, the second operation unit is provided in the recessed portion on the back surface of the remote controller main body. The operation unit may not necessarily be provided on the back surface of the remote controller main body, and the second operation unit may be provided in a region other than the recessed portion on the back surface of the remote controller main body.

In some embodiments, the holder is provided with the dent portion. The holder may not necessarily be provided with the dent portion. In this case, the dent portion may be provided on the second operation unit side. For example, the dent portion may be formed in the depth surface of the recessed portion, and the second operation unit may be provided in such dent portion.

In some embodiments, the shapes, numbers, arrangement positions, and the like of the main-body side magnets and the holder-side magnets are exemplified. However, the present disclosure is not limited to this, but the shapes, numbers, arrangement positions, and the like of the magnets can be changed selectively. For example, the shapes of the magnets may be rod shapes or frame shapes.

In some embodiments, the upper and lower surfaces and the left and right surfaces of the holder are provided with the inclined portions that are inclined at substantially the same gradient as the inclined portions of the upper and lower surfaces and the left and right surfaces of the recessed portion. The present disclosure is not limited to this, but the inclined portions of the holder may not have the same gradient as the inclination portions of the recessed portion, and may be curved surfaces.

In some embodiments, the holder is fitted into the recessed portion of the remote controller main body. In the fitting, there may be a gap between the remote controller main body and the holder.

In some embodiments, the main-body side magnets are provided in the remote controller main body, and the holder-side magnets are provided in the holder. The present disclosure is not limited to this, but a magnet may be provided only in any one of the remote controller main body and the holder.

In some embodiments, the first holding portion and the second holding portion each have a shape that covers the end portion of the remote controller main body. The first restriction portion and the second restriction portion are opposed to the outer surface of the remote controller main body and restrict the movement of the remote controller main body. The present disclosure is not limited to this, but for example, the following configuration may be employed. The first holding portion and the second holding portion may not have peripheral wall portions, but there may be provided protruding walls protruding upward from the end wall portion of the first holding portion and protruding downward from the end wall portion of the second holding portion as the first restriction portions and the second restriction portions. The upper and lower surfaces of the remote controller main body may be formed with groove portions into which the protruding walls are configured to be inserted, so that the protruding walls are inserted in the groove portions and the movement of the remote controller main body is restricted.

In some embodiments, the holder includes the pair of members that are slidable. The present disclosure is not limited to this, but the holder may not have the pair of members that are slidable. For example, there may be employed a form in which one of the pair of holding portions is fixed to the main body portion of the holder, and the other of the holding portions is attached to and detached from the holder.

In some embodiments, the case where the fixing tools that restrict the movement of the pair of members in the separating direction are screws is exemplified. The present disclosure is not limited to this, but the means for restricting the movement may be changed.

In some embodiments, the second operation unit is provided on the back surface of the remote controller main body. The present disclosure is not limited to this, but the second operation unit may not be provided.

In some embodiments, the pair of holding portions sandwich the remote controller main body from above and below. The present disclosure is not limited to this, but for example, the pair of holding portions may sandwich the remote controller main body from the left and right. In this case, the pair of holding portions is provided with the first restriction portions that restrict the movement of the remote controller main body in the up-and-down direction and the second restriction portions that restrict the movement of the remote controller main body to the front side.

In some embodiments, the first restriction portion or the second restriction portion are provided in each of the pair of holding portions. The present disclosure is not limited to this. The first restriction portion or the second restriction portion may be provided only in one of the pair of holding portions. For example, the height dimension of the peripheral wall portion of the first holding portion may be increased, and the peripheral wall portion of the second holding portion may be omitted.

In some embodiments, the first member fixing portions and the second member fixing portions are arranged at positions that coincide with each other on the left and right in the state of being slid. The present disclosure is not limited to this, but for example, an oblong hole may be provided in at least one of the fixing portions so that both fixing portions may be arranged at shifted positions, or a plurality of fixing portions may be provided so that the fixing positions of both fixing portions can be adjusted.

What is claimed is:

1. A toilet remote controller comprising:
an operation unit for operating a toilet device;
a case forming a storage space configured to store an electrical component; and
a cover panel provided at a position corresponding to the operation unit and covering the case with light permeability.

2. The toilet remote controller of claim 1,
wherein the case includes a first case member and a second case member configured to be combined with the first case member and forming the storage space,
wherein the cover panel covers an outer surface of the first case member, and
wherein the second case member includes a cover portion that covers an end portion of the cover panel.

3. The toilet remote controller of claim 1, wherein the cover panel includes a transparent region and an opaque region comprising an embossed outer surface.

4. The toilet remote controller of claim 1, wherein the cover panel includes a display unit provided on an inner surface thereof and on which at least one display of characters, figures, symbols, and patterns is formed.

5. The toilet remote controller of claim 1, wherein a reflective layer is formed on an inner surface side of the cover panel.

6. The toilet remote controller of claim 1, wherein an end portion of the cover panel is curved toward an inner surface side of the cover panel.

7. The toilet remote controller of claim 1, wherein an outer surface of the cover panel is formed in a smooth surface shape.

8. The toilet remote controller of claim 1, comprising a holder that is configured to be fixed to a mounting surface and detachably holds the remote controller main body,
wherein the remote controller main body is provided with a recessed portion, and
wherein the remote controller main body is held on the holder in a state where the holder is positioned in the recessed portion.

9. The toilet remote controller of claim 8, comprising a magnet that fixes the remote controller main body and the holder.

10. The toilet remote controller of claim 8, wherein in a remote controller mounted state in which the remote controller main body is held on the holder fixed to the mounting surface, upper and lower surfaces of the recessed portion and upper and lower surfaces of the holder are positioning portions that position the remote controller main body in an up-and-down direction with respect to the holder.

11. The toilet remote controller of claim 8, wherein in the remote controller mounted state in which the remote controller main body is held on the holder fixed to the mounting surface, the remote controller main body covers an entirety of the holder when viewed from a front side of the mounting surface.

12. The toilet remote controller of claim 8,
wherein the operation unit is a first operation unit, and
wherein the remote controller main body further comprises a second operation unit.

13. The toilet remote controller of claim 12, wherein the second operation unit is provided in the recessed portion.

14. The toilet remote controller of claim 12,
wherein the second operation unit is provided on a surface facing the mounting surface, and
wherein the holder has a dent portion formed in a region opposed to the second operation unit in the remote controller mounted state in which the remote controller main body is held on the holder fixed to the mounting surface.

15. The toilet remote controller of claim 1, comprising a holder that is configured to be fixed to a mounting surface and holds the remote controller main body,
wherein the holder includes a pair of holding portions that restrict movement of the remote controller main body with the remote controller main body interposed therebetween.

16. The toilet remote controller of claim 15,
wherein the pair of holding portions restrict movement of the remote controller main body in one direction along the mounting surface, and
wherein at least one of the pair of holding portions includes a first restriction portion that restricts movement of the remote controller main body in the other direction that intersects the one direction along the mounting surface, and a second restriction portion that restricts movement of the remote controller main body in a direction perpendicular to the mounting surface.

17. The toilet remote controller of claim 15, wherein the holding portion has a shape that covers an end portion of the remote controller main body, and is opposed to an outer surface of the remote controller main body and restricts movement of the remote controller main body.

18. The toilet remote controller of claim 15,
wherein the holder includes a pair of members that are slidable in the one direction,
wherein one of the pair of members is provided with one of the pair of holding portions,
wherein the other of the pair of members is provided with the other of the pair of holding portions, and
wherein the pair of holding portions are movable in an approaching direction and a separating direction.

19. The toilet remote controller of claim 18, further comprising a fixing tool that restricts movement of the pair of members in the separating direction.

20. The toilet remote controller of claim 15,
wherein the operation unit is a first operation unit, and
wherein in a state where the remote controller main body is held on the holder fixed to the mounting surface, a second operation unit is provided on a surface of the remote controller main body facing the mounting surface.
